(19) United States
(12) Patent Application Publication
(10) Pub. No.: US 2024/0116169 A1
(43) Pub. Date: Apr. 11, 2024

(54) Design and Sensing of Affordable Wearable Robots Without Torque Sensors

(71) Applicant: North Carolina State University, Raleigh, NC (US)

(72) Inventor: Hao Su, Raleigh, NC (US)

(21) Appl. No.: 18/372,630

(22) Filed: Sep. 25, 2023

Related U.S. Application Data
(60) Provisional application No. 63/409,693, filed on Sep. 23, 2022.

(51) Int. Cl. B25J 9/00; A61H 3/00; B25J 9/16

(52) U.S. Cl. CPC B25J 9/0006; A61H 3/00; B25J 9/1633; A61H 2205/06; A61H 2205/088; A61H 2205/102

(57) ABSTRACT

Various examples are provided related to control of a wearable robot without torque sensors. In one example, a method includes generating a control signal for a quasi-direct-drive (QDD) actuator of the wearable robot and adjusting operation of the QDD actuator based upon the control signal. The control signal can be determined by a collocated controller using current and angle of rotation of the QDD actuator and a reference trajectory angle. In another example, a wearable robot includes a support structure that can interface with a user; a quasi-direct-drive (QDD) actuator coupled to the support structure; and processing circuitry that can generate a control signal for the QDD actuator, the control signal determined by a collocated controller based upon current and angle of rotation of the QDD actuator and a reference trajectory angle and adjust operation of the QDD actuator based upon the control signal.

### CROSS REFERENCE TO RELATED APPLICATIONS

This application claims priority to, and the benefit of, co-pending U.S. provisional application entitled “Design and Sensing of Affordable Wearable Robots without Torque Sensors” having Ser. No. 63/409,693, filed Sep. 23, 2022, which is hereby incorporated by reference in its entirety.

### STATEMENT REGARDING FEDERALLY SPONSORED RESEARCH OR DEVELOPMENT

This invention was made with government support under grant numbers CMMI1944655 and CMMI2227091 awarded by the National Science Foundation. The government has certain rights in the invention.

### BACKGROUND

The design of actuators and controller strategies with high accuracy without torque sensors and high stability has been one of the challenges in wearable robotics research. The conventional actuator typically needs torque sensors to command torque accurately to decrease the effect of unmodeled dynamics and common uncertainties. The series elastic actuators, the most popular actuator, can estimate output torque via the deflection of an elastic element but add additional components (like springs), size, mass, and complexity. In addition, the two popularized actuator paradigms often use exteroceptive sensory feedback that is known to cause non-collocated sensing problems upon collision, which results in human-robot-interaction instability.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1C illustrate examples of a conventional actuator, series elastic actuator (SEA), and a quasi-direct drive (QDD) actuator, in accordance with various embodiments of the present disclosure.

FIGS. 2A-2C illustrate examples of non-collocated and collocated actuation systems, in accordance with various embodiments of the present disclosure.

FIG. 3 illustrates an example of modeling of a wearable robot interacting with a human limb, in accordance with various embodiments of the present disclosure.

FIG. 4 is a block diagram illustrating an example of a wearable robot controller comprising wearable robot hardware, low-level/collocated controller, and high-level controller, in accordance with various embodiments of the present disclosure.

FIG. 5 is a block diagram illustrating an example of a collocated impedance controller, in accordance with various embodiments of the present disclosure.

FIG. 6 includes tables illustrating examples of parameters of a human-exoskeleton coupled model and a human model, in accordance with various embodiments of the present disclosure.

FIGS. 7A-7D illustrate examples of estimation error, in accordance with various embodiments of the present disclosure.

FIGS. 8A and 8B illustrate examples of root locus and bode diagram of collocated control of QDD and non-collocated control of SEA, in accordance with various embodiments of the present disclosure.

FIG. 9 illustrates examples of system parameters effects on closed-loop system poles of the transfer function, in accordance with various embodiments of the present disclosure.

FIG. 10 illustrates an example of a knee exoskeleton and images of experimental setup, in accordance with various embodiments of the present disclosure.

FIG. 11 is a block diagram illustrating an example of an open-loop transfer function, in accordance with various embodiments of the present disclosure.

FIG. 12 illustrates a bode diagram of the model curve of the knee exoskeleton, in accordance with various embodiments of the present disclosure.

FIGS. 13 and 14 illustrate examples of experimental test results, in accordance with various embodiments of the present disclosure.

FIGS. 15A and 15B illustrate examples of experimental stability results, in accordance with various embodiments of the present disclosure.

FIGS. 16A-16C illustrate examples of a SEA-based exoskeleton and QDD actuator-based exoskeletons with and without torque sensor, in accordance with various embodiments of the present disclosure.

FIG. 17 illustrates an example of non-collocated actuation system, in accordance with various embodiments of the present disclosure.

FIG. 18 illustrates an example of modeling of a wearable robot interacting with QDD actuator and human limb, in accordance with various embodiments of the present disclosure.

FIG. 19 is a block diagram illustrating an example of a wearable robot controller comprising and wearable robot hardware, low-level/collocated controller, and high-level controller, in accordance with various embodiments of the present disclosure.

FIG. 20 illustrates an example of a collocated controller design procedure, in accordance with various embodiments of the present disclosure.

FIGS. 21A-21D illustrate examples of a collocated impedance controller, collocated direct torque controller, and collocated admittance controller for QDD-based exoskeletons, in accordance with various embodiments of the present disclosure.

FIG. 22 is a block diagram representing a non-collocated impedance control scheme for exoskeletons with SEA and QDD actuator, in accordance with various embodiments of the present disclosure.

FIGS. 23A and 23B illustrate examples of root locus and bode diagram of non-collocated control of the SEA-based exoskeleton and collocated control of the QDD-based exoskeleton, in accordance with various embodiments of the present disclosure.

FIG. 24 illustrates a comparison between current-based and the torque estimation method for different gear ratios and frequencies, in accordance with various embodiments of the present disclosure.

FIG. 25 illustrates an example of exoskeleton test results, in accordance with various embodiments of the present disclosure.

FIG. 26 illustrate examples of experimental stability results, in accordance with various embodiments of the present disclosure.

FIG. 27 illustrates a comparison of torque estimation test results, in accordance with various embodiments of the present disclosure.

FIG. 28 is a block diagram illustrating an example of processing circuitry for implementing wearable robot control, in accordance with various embodiments of the present disclosure.

### DETAILED DESCRIPTION

Disclosed herein are various examples related to control of a wearable robot without torque sensors. To solve challenges with human-robot-interaction instability, a collocated impedance control based on proprioceptive quasi-direct drive (QDD) actuators has been developed to improve stability and high accuracy for knee exoskeletons. The proposed controller without torque estimator can compensate for the transmission losses and render more accurate impedance control but does not need a torque sensor as signal feedback. The sensorless torque can significantly improve the lightweight and cost-effectiveness of wearable robots. In addition to exoskeletons and other wearable robots, the controls can be applied to robotic prosthetics and humanoid robots. Root locus results demonstrate that the collocated system is exponentially stable. Torque estimation results were evaluated in human walking tests. The RMS error of the estimated torque (without sensor) is only 0.68 Nm (5.3% of the peak of 12 Nm), while the torque tracking RMS error is 0.58 Nm (with torque sensor, 4.8%), indicating that the design can render a more extensive stability region without a torque sensor for feedback while keeping equivalent accuracy to the ones with torque sensors. Reference will now be made in detail to the description of the embodiments as illustrated in the drawings, wherein like reference numbers indicate like parts throughout the several views.

Wearable robotic systems—like exoskeletons and prostheses—offer great promise to enhance and restore human mobility. Exoskeletons are connected in parallel with the user and work in harmony with the user's upper or lower limbs. They have been extensively used as both rehabilitation and assistive devices, for example, spinal cord injury (SCI) compensation, post-stroke rehabilitation, resistance exercises, human power augmentation, and activities of daily living (ADL) support. Whereas prostheses are connected in series with the user and are used to restore human mobility by mimicking the missing biological limb to replicate the nominal gait pattern similar to that of nonamputee individuals. Therefore, wearable robots should be highly versatile to meet the varying movement needs of activities of daily living. Since the interaction dynamics exist between the actuators and human limbs, the design of actuators and controllers highly influence the versatility of the wearable robots. Hence, their design should meet multifaceted needs to ensure safety, high stability, high bandwidth, high compliance and high ability to manage human-robot interactions.

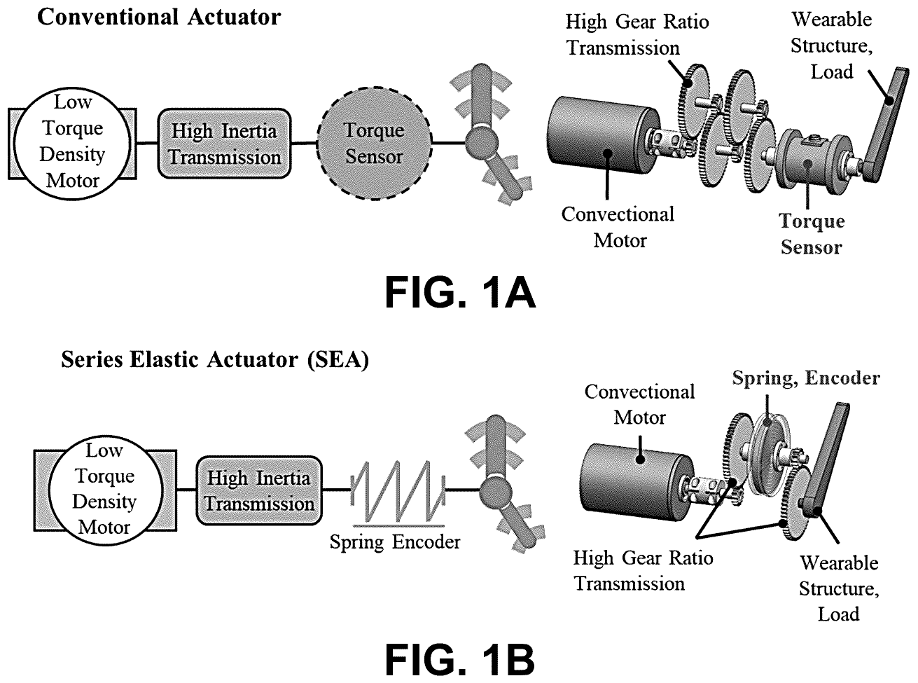

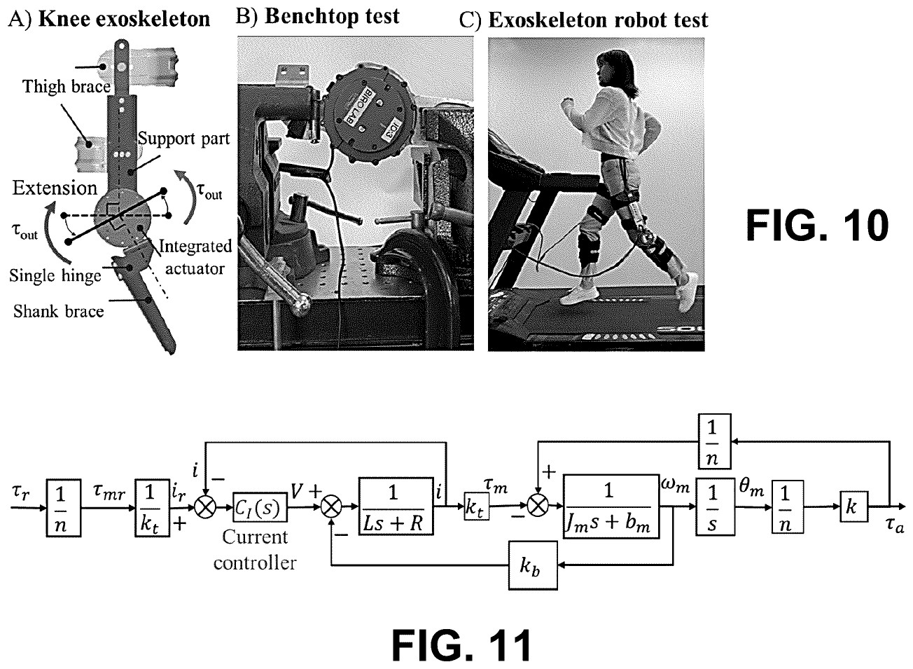

FIGS. 1A-1C illustrate examples of three actuation paradigms. FIG. 1A shows a conventional actuator paradigm where an electric motor is coupled with high ratio transmission to generate the torque. Torque sensors are generally used to provide exteroceptive feedback signal for compliant and accurate control. FIG. 1B shows a Series Elastic Actuator (SEA) paradigm comprising an electric motor and high ratio transmission but leveraging an elastic element to inject passive compliance. The deflection of the elastic element is measured to estimate the output torque. FIG. 10 shows a quasi-direct drive (QDD) actuator leveraging high torque density motors paired with low ratio transmission which allows for inherit compliance and accurate torque estimation based on an actuator model.

Although conventional actuation paradigm allow for high bandwidth and high stability, they often lack compliance and efficiency. This is due to use of high-ratio transmissions which produce high mechanical impedance at the wearable robot joints making it difficult to back-drive without continuous intervention from the controller. Closed-loop torque and impedance control have been proposed to introduce compliance by using exteroceptive torque sensors to close feedback loop. Alternatively, Series Elastic Actuator (SEA) actuators have been proposed where an elastic element is placed between the gear train and driven load to intentionally reduce the stiffness of the actuator and allow for passive compliance. The output torque is modulated by controlling the deformation of elastic elements whereas backdriveability is increased by reversing the deformation. This way SEA alleviates the problem of inhibiting natural human movements which is commonly observed when conventional actuation paradigm is adopted. Therefore, SEA actuator compared with the conventional actuator has greater shock tolerance, less inadvertent damage to the environment (human), and the capacity for energy storage.

A lower-back robotic exoskeleton has been proposed to provide spinal support for users, which has a spring element to improve compliance and torque sensors integrated into SEA to provide the torque measurement. A clutchable series-elastic actuator was designed for a prosthetic, which could efficiently store energy in the series elasticity. However, due to complex mechanical design and low transparency (due to high gear ratio) of SEA actuators, the position or torque sensor (or both) are typically necessary to provide feedback to decrease the effect of unmodeled dynamics and common uncertainties.

One of the fundamental challenges for economic and lightweight wearable robots is improving the sensing and actuator mechanism. However, torque sensors used in the common actuation paradigms have some limitations, e.g., usually they are expensive (up to $1000), fragile (e.g., prosthesis contact the ground) and have finite response time and resolution. Furthermore, the torque sensors tend to be large and heavy (generally 0.4 kg each). Moreover, the use of an elastic element in the SEA paradigm adds to the overall size and mass of the actuator while lowering the bandwidth. Therefore, it is beneficial to develop an actuation paradigm to alleviate the exteroceptive feedback sensors, specifically torque sensors to not only lower the weight but also the cost of the wearable robot without compromising the performance. Recently, lightweight and low-cost actuators called Quasi-direct drive (QDD) actuators have been used that have high torque density motors and low gear ratio transmission, to reduce the overall cost and weight. QDD actuators have been used in hip and prosthesis where the actuators' high bandwidth and high compliance has been successfully established. However, torque sensors were still used in these wearable robots to measure the output torque as control feedback which limits the design of ultra-light exoskeleton and its affordability.

To overcome this limitation, a novel torque estimation method has been designed enabling proprioceptive QDD actuators of wearable robots. Owing to the low gear ratio and consequent lower reflected inertia, QDD actuators can facilitate accurate estimation of output torque. Although SEA also enables output torque estimation based on the deflection of an elastic element without the need for exteroceptive torque feedback, its use of elastic elements adds size, mass, and complexity. Furthermore, “open-loop” control involving SEA actuators, following collocated control paradigm, estimate output torque based on the motor torque (current times torque constant) and transmission (gear ratio). However, it lacks accurate output dynamics, and the difference between the desired and actual output torque has yet to be quantified. The proposed estimation method (instead of I*Kₜ) can achieve high fidelity torque estimation without relying on a torque sensor thus making the wearable robot economical and lightweight.

Guaranteeing control stability is another fundamental challenge for a wearable robot. One commonly used control paradigm for SEA is non-collocated control where the elastic element is located between the actuator and sensor. However, this control method suffers from limited feedback gains and is sensitive to torque control gain that warrants rigorous handcrafting of gains. Additionally, in such a configuration, the actuator and sensor can vibrate out of phase thus, SEA can suffer from stability and limited bandwidth problem. Lastly, the use of exteroceptive sensory feedback is known to cause non-collocated sensing problems upon collision, which results in human-robot-interaction instability. SEA with non-collocated control works well in normal conditions (like walking and squatting) but it is challenging to adapt to more agile human activities which require high bandwidth control (like running) or unexpected perturbations.

To solve the challenge of guaranteeing control stability control, a collocated control was created based on quasi-direct drive actuator in wearable robots. The high bandwidth, high compliance performance, and compact mechanical design of QDD provides the foundation for collocated control with no spring stiffness limitation. Collocated control has alternating poles and zeros that could render a larger stability region.

The proposed collocated control of proprioceptive QDD can ensure high fidelity torque estimation without a torque sensor and can render a more extensive stability region for wearable robots. Torque estimation: the QDD with torque estimator can accurately estimate output torque without a torque sensor Stability: out collocated control can render a larger stability region and ensure stability without a complex gain turning process Benefits: an design, a simpler, more lightweight is offered; in sensors, fewer sensors and a more cost-effective design is offered; in control, a larger stability region is offered.

Modeling and Control Architecture of Wearable Robot System

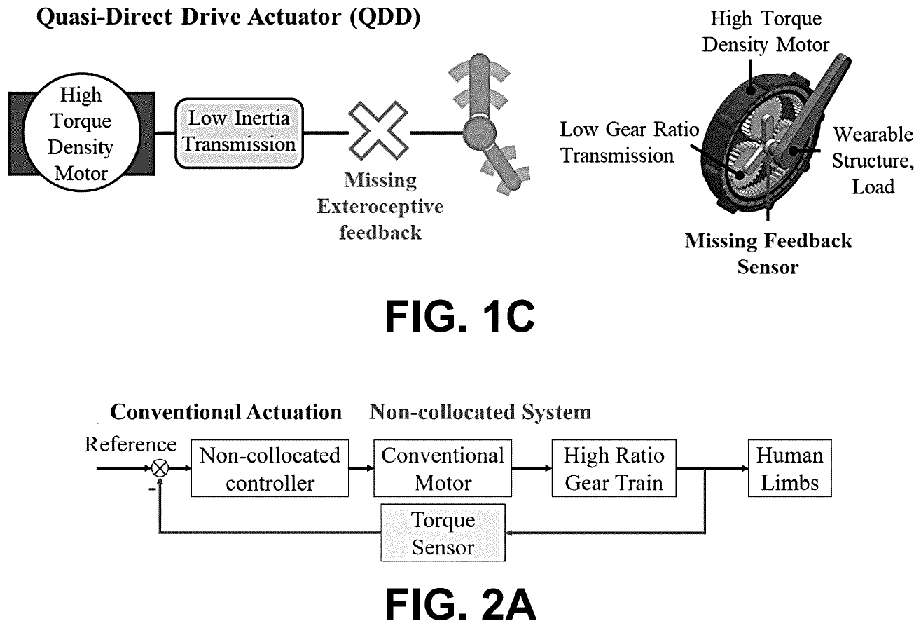

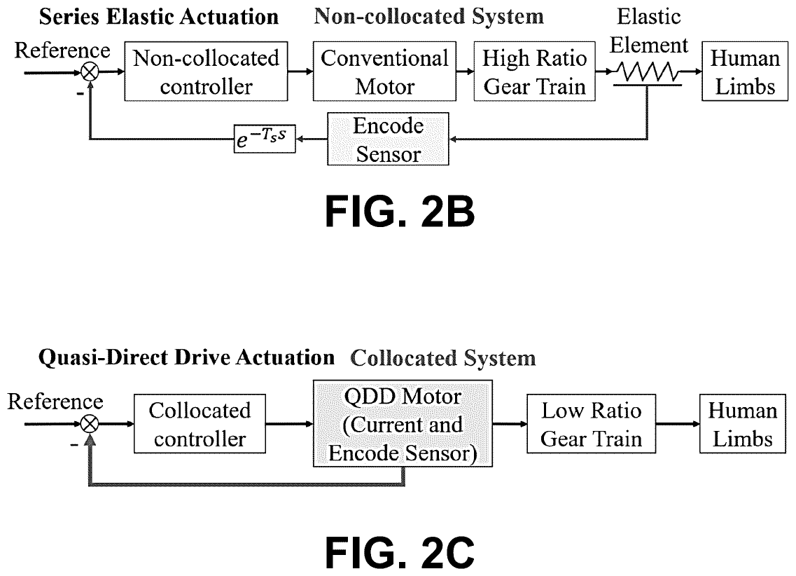

The influence of human-robot interaction between the wearable robot and the human limbs significantly differentiates the wearable robots from other robots. The wearable robots rely on continuous acquisition of limited amount of data pertaining to human kinematics and the interaction between human and the robot to facilitate the assistance, which utilizes highly sophisticated sensing and control of the robot to promote beneficial aid for the wearers. Therefore, accurate modeling of human-robot interaction has a direct influence on efficacy of wearable robots. Modeling of the wearable robot interacting with human limbs and the control architectures of the wearable robot is presented in this section. FIGS. 2A-2C illustrate the human-robot interaction paradigm involving various commonly used actuators. FIG. 2A illustrates an example of a conventional actuation approach, FIG. 2B illustrates an example of a series elastic actuation approach and FIG. 2C illustrates an example of a quasi-direct drive actuation. A wearable robot interacting with human limbs can be modeled using three components: 1) quasi-direct drive actuator, 2) wearable structure, and 3) human limbs. FIG. 3 illustrates modeling of the wearable robot interacting with the human limb. The simplified structure of the human-robot interaction model is broken down into quasi-direct drive actuator, wearable structure, and human limb. Here, τₘ is the motor torque, τ₁ is the torque generated by output shaft of the motor and τ₂ is the torque generated by the output shaft of transmission, τₐ is the actual torque transmitted to the human limb and θₕ is the human joint angle. The first two components make up part of the wearable robot, where the actuator provides assistive torque, and the wearable structure transmits the assistive torque to the human limb. A detailed description of the three components is as follows.

A. Modeling of Wearable Robot System

Modeling of Quasi-Direct Drive Actuators: The actuator encapsulates the mechatronic components, including the control circuit, motor, and gearbox. In this work, consider electronic motors (comprising a resistor, inductor, and ideal motor) that generate torque τₘ based on circuit current i and motor rotation generates Back Electro-Motive Force (EMF) voltage. Thus, based on the Kirchhoff's Voltage Law, this can be expressed as:

$$L \frac{di}{dt} + Ri + {V}_{b} = V . \qquad ( 1 )$$

Here, back EMF voltage V_{b} is proportional to the motor's angular velocity, i.e., V_{b}=k_{b}\dot{θ}ₘ, where k_{b} is the constant of back EMF and θₘ is the angle of motor rotation. Additionally, the motor output torque is proportional to circuit current, i.e., τₘ=kₜi.

Therefore, the mechanical model of motor can be formulated as:

τₘ=Jₘ\ddot{θ}ₘ+bₘ\dot{θ}ₘ+τ₁, (2)

where Jₘ is motor rotor inertia, bₘ is motor damping coefficient and, τ₁ is the torque applied to the input shaft of the gearbox (gear ratio is n:1.).

As, the gear box is used to magnify torque T 1 by reducing output angle, then:

θₘ=θ₁=nθ₂, τ₂=nτ₁, (3)

where θ₁ and θ₂ are the rotation angle of the input shaft and output shaft of the gearbox, respectively, and τ₂ denotes the torque applied by the output shaft. Using Eqs. (2) and (3), the actuation model can be written as:

θ₂=n[τₘ−Jₘ\ddot{θ}ₘ−bₘ\dot{θ}ₘ]. (4)

Modeling of Wearable Structure: The wearable structure of the wearable robot acts as the transmission component that transmits the torque generated by the actuator to the human limb. The wearable structure was designed by using braces, straps, and rigid linkages. The wearable structure was modeled as a transmission stiffness k. Thus, the wearable structure can be modeled with respect to the components it connects with as follows:

$${τ}_{a} = k ( {τ}_{2} ) = k ( {θ}_{2} - {θ}_{h} ) = k ( \frac{1}{n} {θ}_{m} - {θ}_{h} ) , \qquad ( 5 )$$

where θₕ is the human joint angle.

Modeling of Human Limbs: The human limb is modeled as a second-order system with:

Jₕ\ddot{θ}ₕ+bₕ\dot{θ}ₘ+kₕθₖ=τₜₒₜₐₗ, (6)

where τₜₒₜₐₗ=τₐ+τₕ, and τₜₒₜₐₗ is the sum of torque exerted on the human limb by the wearable robot (τₐ) and torque generated by the human limb (τₕ). Next, to concoct the transfer function between the assistive torque and human joint angle, assume that the wearable robot provides a fixed percentage of the total needed torque to assist the limb movement, i.e., τₐ=ατₜₒₜₐₗ. With this in mind, the transfer function can be defined as,

$$H ( s ) = \frac{{θ}_{h}}{{τ}_{a}} = \frac{{θ}_{h}}{α {τ}_{h}} . \qquad ( 7 )$$

θₕ can relate to τₜₒₜₐₗ as follows:

(Jₕs²+bₕs+kₕ)θₕ(s)= [symbol] ₜₒₜₐₗ(s) (8)

By substituting Eq. (8) into Eq. (7), the transfer function of human limbs can be given by:

$$H ( s ) = \frac{{θ}_{h}}{{τ}_{e}} = \frac{1}{α ( {J}_{h} {s}^{2} + {b}_{h} s + {k}_{h} )} . \qquad ( 9 )$$

### B. Control Architecture of Wearable Robots

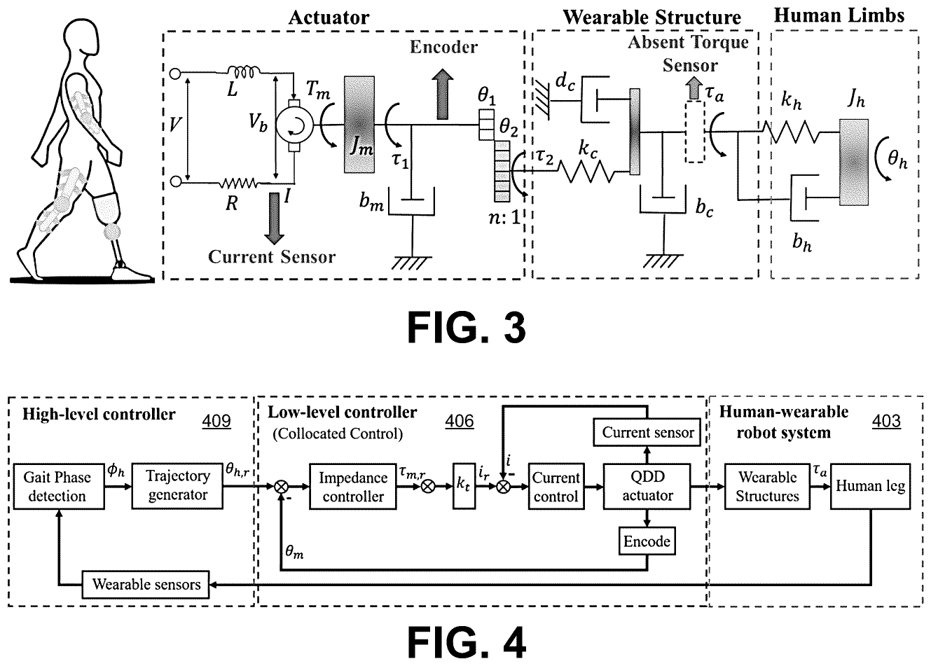

To achieve efficient assistance, the wearable robot can be controlled to generate assistive torque at the right time. FIG. 4 is a schematic block diagram illustrating an example of a wearable robot controller comprising wearable robot hardware (403), low-level/collocated controller (406), and high-level controller (409). The high-level controller 409 comprises a gait event detection algorithm that can detect gait events based on wearable sensor measurements and a position trajectory generator that can generate desired human position (based on the gait events). The low-level controller 406 can regulate control effort for actuator system to track the desired position generated by high-level controller. As shown in FIG. 4, the control system of the wearable robot can be decomposed into two levels: the high-level and low-level controllers. The main objective of the high-level controller 409 is to continuously generate the reference trajectory for human limb in real-time during activities of daily living, such as walking, running, and stair climbing. The low-level controller 406 then continuously maps the reference trajectory to the desired assistive torque that should be generated by the actuator.

Torque Control and Impedance Control: To provide the assistive torque, two approaches can be applied: 1) direct torque control and 2) indirect torque control also known as impedance control. The direct torque control approach tracks the desired reference torque signal to generate accurate assistive torque for the human limb. However, although this approach can generate desired assistive torque, it is known to lack the ability to control the mechanical work exchanged between the wearable robot and its environment leading to the possibility of generating high impact forces. Thus, imposing stringent reference torque trajectory constraint makes the wearable robot less compliant and potentially unsafe.

Contrary to direct torque control, impedance control is an indirect control approach that does not control the force exerted to the environment (human) but rather a behavior to an external force based on the position error of the wearable robot and human joints. Thus, impedance control approaches usually regulate the mechanical impedance reflected by the wearable robots, which take advantage of the interaction torque between the robot and the human limb. Since impedance control emulates a spring-damper system between the wearable robot and the environment(human), it facilitates safe and energy efficient interaction between the user and the wearable robot; making it a viable control approach for wearable robot control.

Non-collocated Control and Collocated Control: Depending on the location of the feedback sensors, the control approaches can be classified into two categories: non-collocated control and collocated control. FIGS. 2A-2C illustrate the block diagrams of the commonly used actuators in non-collocated control mode and QDD actuator used in collocated control model. In collocated control, shown in FIG. 2C, the sensor providing the feedback signal is situated at the same location as the actuator generating the input torque. Thus, the need for exteroceptive sensory feedback is averted. On the contrary, non-collocated control stands for the control scheme where the sensor and the actuation element are placed at different locations.

For the three actuation schemes shown in FIGS. 1A-1C, the conventional actuation (FIG. 2A) and series elastic actuation (FIG. 2B) schemes utilize the feedback signal from the sensors located at the human limb side. Since the feedback sensors and actuation elements are placed at different locations, they are classified into non-collocated control schemes. Whereas, the quasi-direct drive scheme shown in FIG. 2C leverages the feedback sensors placed at the same location as the motor, thus it is classified as collocated control.

Collocated Impedance Controller of Quasi-Direct Drive Actuators: FIG. 4 illustrates the proposed model of the control system. The encoder and the current sensor, located at the QDD actuator side, resemble proprioceptive sensors and are used as feedback sensors to estimate the generated assistive torque. Thus, the feedback sensors such as high-cost torque sensors located at the end-effector side, used in conventional actuator and SEA actuation paradigm, can be eliminated. Thus, all the sensors are located at the actuator side, which is harmonious with the collocated control scheme. To achieve the collocated torque control, the motor encoder signals are leveraged as the feedback signal of the system. Thus, from the reference angle trajectory generated by the high-level controller and the real-time angle feedback obtained from the encoder, an impedance controller can be implemented to generate the desired torque.

The wearable robot can be expected to show a desired impedance at the end-effector given by:

[∝ₕ−θ_{h,r}]k_{d}+[\dot{θ}ₕ−\dot{θ}_{h,r}]b_{d}=− [symbol] ₐ, (10)

where the desired stiffness coefficient k_{d} and desired damping coefficient b_{d} compose the target impedance for Voigt model (a purely viscous damper and purely elastic spring connected in parallel). Next, using the relationship

$${\dot{θ}}_{h} ( t ) = \frac{1}{n} {\dot{θ}}_{m} ( t )$$

and substituting model of human and wearable robot Eq. (5) into Eq. (6). After Laplace transform and further simplification, the result can be given as:

$${τ}_{a} ( s ) = \frac{k}{k - {k}_{d}} ( {k}_{d} + {b}_{d} s ) [ {θ}_{h , s} - \frac{1}{n} {θ}_{m} ( s ) ] . \qquad ( 11 )$$

Since the wearable robot system is collocated, τₐ(s) cannot be measured using a torque sensor, but the equation of τₘ(s) could be given by Eqs. (5) and (7):

$${τ}_{m} ( s ) = \frac{1}{n} \frac{k}{k - {k}_{d}} ( {k}_{d} + {b}_{d} s ) [ {θ}_{h , r} ( s ) - \frac{1}{n} {θ}_{m} ( s ) ] + {J}_{m} {{s}^{2} ( θ )}_{m} ( s ) + {b}_{m} s {θ}_{m} ( s ) . \qquad ( 12 )$$

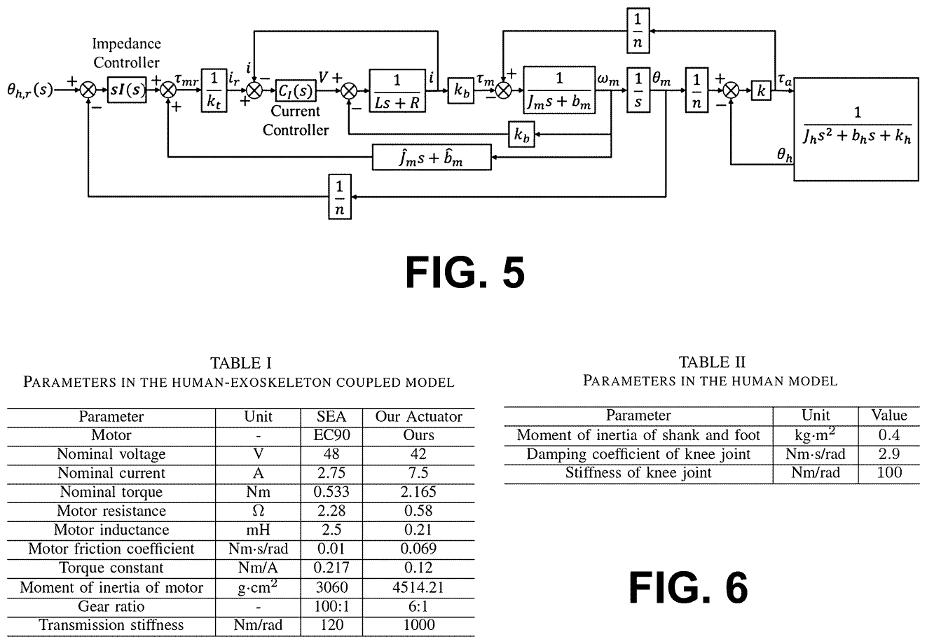

Therefore, as shown in the block diagram of FIG. 5, the collocated impedance control law can be given by:

$${τ}_{m} ( s ) = sI ( s ) [ {θ}_{h , r} ( s ) - \frac{1}{n} {θ}_{m} ( s ) ] + {J}_{m} {s}^{2} {θ}_{m} ( s ) + {b}_{m} s {θ}_{m} ( s ) , \qquad ( 13 )$$

$$where sI ( s ) = \frac{1}{n} \frac{k}{k - {k}_{d}} ( {k}_{d} + {b}_{d} s ) . \qquad ( 14 )$$

The τₐ and θₕ are non-collocated signals, which cannot be used as the feedback in the collocated control diagram. Only current signal i, motor angle θₘ and angular velocity \dot{θ}ₘ signals can be used for feedback. The impedance controller is shown in Eq. (14) and the current control is a PD controller.

### High-Fidelity Torque Estimation Without a Torque Sensor

Most of the control architectures rely on exteroceptive sensory measurement as the feedback to generate appropriate assistive torque. This negatively affects the cost and weight of the wearable robot because commonly used torque sensors are bulky, costly, and heavy. A commonly used approach to avert the use of torque sensing components is to adopt an “open-loop” control approach where current is used to estimate the torque. But this approach generally suffers from low torque estimation accuracy due to the unmodeled dynamics and common uncertainties of inertia which warrants for torque feedback to improve accuracy. Therefore, accurate torque estimation has been a significant challenge for wearable robots.

In general, the factors negatively affecting the torque estimation accuracy can be classified into two categories: (1) inaccuracies in unmodeled dynamics and (2) measurement error. Inaccuracies in the dynamics modelling of the system may lower the torque estimation accuracy during real-world use. This is because accurately modelling various aspects of a real-world system can be challenging or may involve complex nonlinear features. However, such inaccuracies in dynamics modelling are generally ignored in various studies where assumptions and generic fixes are implemented. Measurement errors in motor shaft position have also been seen to affect the torque estimation accuracy. For instance, encoders are widely used to measure the angular displacement which is then differentiated to compute angular velocity. Minor errors in the sensing data may get augmented over long-term use in real time which may affect the torque estimation, which usually use angle information and angular velocity to estimate torque. However, such measurement errors have a minor effect on accuracy of estimated output torque, and thus can be ignored. Therefore, to improve torque estimation accuracy these types of errors need to be accounted for.

### A. Formulation of Torque Estimation

Torque Estimation with Current Sensor. A commonly used approach of torque estimation is to estimate the torque from the current using τ=nkₜi, where n is the gear ratio of the transmission, kₜ is the torque constant, and i is the current of the motor. This approach is highly feasible since most actuators have built in current sensors. However, this equation generally cannot provide accurate estimations as the dynamic effects, such as backlash, vibration, and friction in the transmission is not modelled. These dynamic effects affect the estimation accuracy primarily because high gear ratio transmission (e.g., 100:1) magnifies the error significantly. One way to avert this is to reduce the gear ratio of the transmission. With a much smaller gear ratio, the error caused by unmodeled dynamics can be significantly reduced. However, even though a smaller gear ratio can significantly reduce the torque estimation error, minor errors still exist which cannot be mitigated due to the non-negligible dynamics being unmodeled.

Torque Estimation with Our Dynamic Model: To further reduce the torque estimation error due to unmodelled dynamics with low gear ratio, the dynamics model was incorporated in the approach. The output torque τₐ can be expressed in terms of the system parameters and the input reference, which can be given by:

$${τ}_{a} = k ( \frac{1}{n} {θ}_{m} - {θ}_{h} ) = \frac{{n}_{τ , mea} ( s )}{{d}_{τ , mea} ( s )} {θ}_{hr} \qquad ( 15 )$$

and the estimated assistive torque τₑₛₜᵢₘₐₜₑ can be given by:

$${τ}_{estimate} = nsI ( s ) ( {θ}_{h , r} - \frac{1}{n} {θ}_{m} ) = \frac{{n}_{τ , est} ( s )}{{d}_{τ , est} ( s )} {θ}_{hr} . \qquad ( 16 )$$

This approach uses the reference angle and motor side angle feedback to achieve the high-fidelity torque estimation. Since the dynamics of the whole mechatronic system is considered and properly compensated, it naturally provides more accurate estimations that other approaches. Benefiting from the low gear ratio, the error is not magnified significantly as the traditional high gear ratio solutions. Another reason is related to the inertial impedance of the mechanical system. Since mechanical systems generally cannot respond as fast as electrical systems, a larger moment of inertia or inertial impedance would affect the response speed of the mechanical system which further contributes towards the phase delay. The inertial impedance is positively related to the square of the gear ratio n. It can be easily inferred that any increase to the gear ratio would significantly affect n² and the inertial impedance. Quasi-direct drive actuators avoid this issue by reducing the gear ratio and possibly reducing the moment of inertia which in turn improves torque estimation accuracy.

The torque estimation accuracy can be defined with the relative error:

$$Relative Error := \vert 1 - \frac{‖ {τ}_{est}^{ss} ‖ {ℒ}_{∞}}{‖ {τ}_{mea}^{ss} ‖ {ℒ}_{∞}} \vert . \qquad ( 17 )$$

where τ_{(·)}^{ss} stands for the steady-state of τ_{(·)},

∥x∥ [symbol] _{∞}:=sup ∥x(t)∥_{t≥t}_{₀}. (18)

If [symbol] <∞ (the signal is bounded for all time), than x(t)∈ [symbol] _{∞}.

### B. Factors Affecting Torque Estimation

Factors that affect the torque estimation accuracy were identified and include the gear ratio of the transmission n, the moment of inertia of the motor Jₘ, the damping coefficient bₘ, motor resistance R, motor inductance L, the low-level control gains kₚ and k_{I}, and human limb dynamics Jₕ, bₕ, and kₕ. How these parameters affect the result will be shown by fixing a parameter and adjusting another. Among these parameters, four sets of parameters were identified that affect the accuracy the most. These include: 1) hardware design factors n and Jₘ, 2) low-level control gains k_{P} and k_{I}, 3) human joint dynamics Jₕ, bₕ, and kₕ, and 4) human joint motion frequency ω.

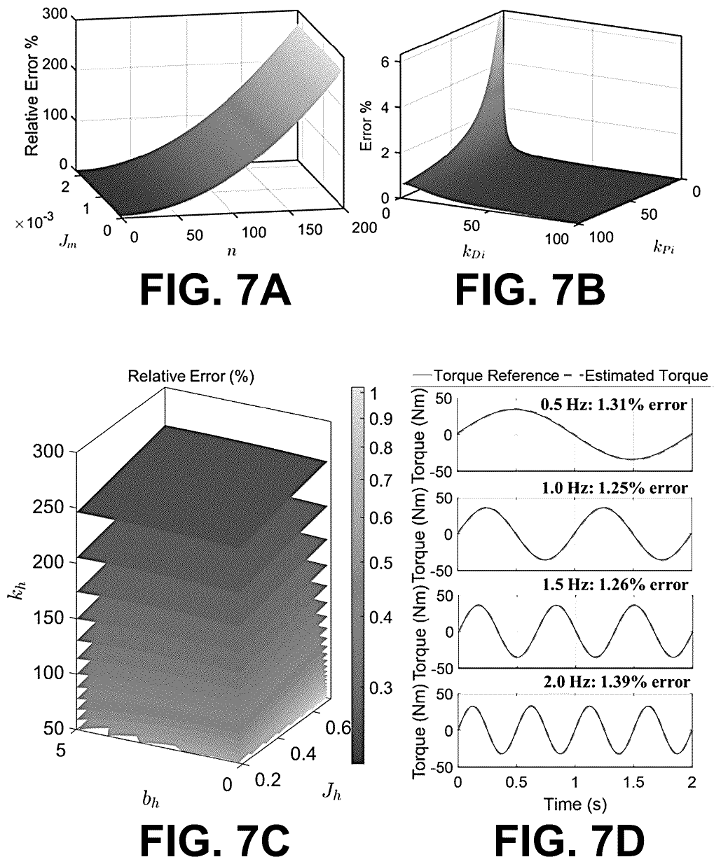

The benchmark parameters used in the simulation are shown in Table I of FIG. 6. The model employed in this analysis was from an exoskeleton designed and manufactured in the lab. The effect of these parameters on the torque estimation error was analyzed by adjusting a group of parameters around the benchmark configurations and fixing all other parameters.

To facilitate the human-robot interaction analysis, the human knee joint parameters used to build up the model for analysis are shown in Table II of FIG. 6. Since this work doesn't focus on the human biomechanics, the data was only used to form the region of human joint parameters. It is worth noting that the damping coefficient and stiffness of human knee joint can change greatly due to the status of activity.

In the following analysis, a sinusoidal signal θ_{h,r}=A sin(ωt) was used as the reference angle. It is worth noting that the assumption of a sinusoidal function doesn't limit the applicability of this result. Since a continuous function can be decomposed into the sum of sinusoidal curves using Fourier transform, the sinusoidal function at each frequency can be transformed in the frequency domain using the Laplace transform. Due to the linearity of Laplace transform and inverse Laplace transform, the final error of all frequency is actually the integral of the error in all frequencies.

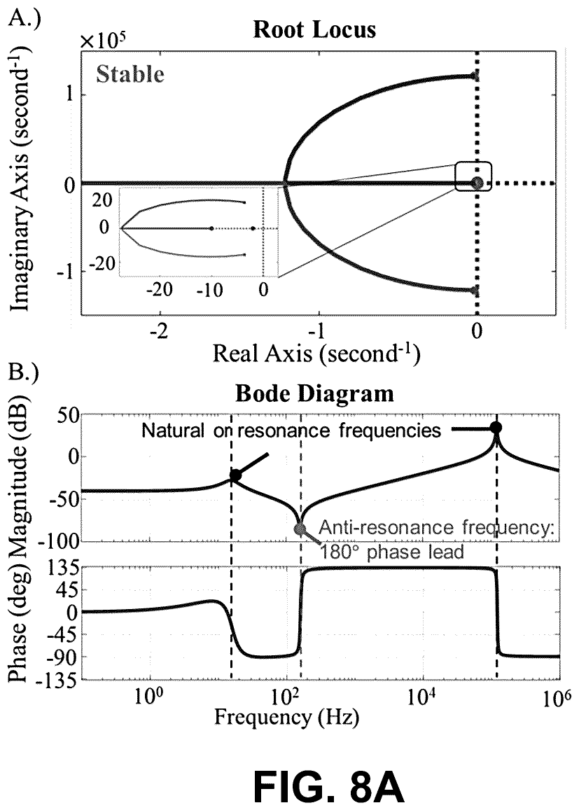

Hardware design factors: The hardware design factors can play an important role in the torque estimation error. The moment of inertia of the motor can cause the system to not be able to respond to the reference signal, consequently causing an error. Furthermore, the gear ratio may augment the error, thus lowering the output torque estimation accuracy. However, the result partially validates the guess. FIG. 7A illustrates an example of the torque estimation error (%) with respect to the gear ratio of the transmission (n) and the moment of interia of the motor (Jₘ). As shown in FIG. 7A, the gear ratio spans over the range from 1 to 200, and the moment of inertia of the motor was selected between Jₘ/5 to 5Jₘ. The result shows that, the error was increasing with respect to the gear ratio, but not sensitive to the moment of inertia.

Low-level control gains: It is already established that the low-level control gains can effect the torque estimation error. FIG. 7B illustrates an example of the torque estimation error (%) with respect to the low-level gains gains k_{P} and k_{I}. The result shows that the error reduces rapidly with increasing low-level control gains k_{P} and k_{I}. Once the values of k_{P} and k_{I} are greater than a threshold value, the error becomes negligible. This is actually a good thing since the low-level control gains can greatly affect the system performance. With a larger range while keeping the same torque estimation accuracy, the system has more freedom in making compromises in other aspects.

Human joint dynamics: It can be easily inferred that the human joint dynamics can significantly influence the torque estimation error. However, the model needs to be robust to varying joint dynamics while maintaining a high estimation accuracy. FIG. 7C is a contour plot of torque estimation error (%) with respect to the human limb parameters Jₕ, bₕ, and kₕ, which indicates that the model can maintain high accuracy under varying human knee joint dynamics.

Human joint motion frequency: The last factor affecting the output torque estimation accuracy is the human joint motion frequency. The system is sensitive to these frequencies. FIG. 7D illustrates an example of the measured and estimated torque at different frequencies (ω=0.5, 1.0, 1.5 and 2.0 Hz). FIG. 7D shows that, although there was a slight increase in the error at higher frequencies, the method still achieved higher torque estimation accuracy in the frequency range of normal human activities.

### Passivity and Stability Analysis of Collocated and Non-Collocated Control Architectures

The stability of the system and the margin in which the system is stable are important characteristics of the system due to the fact that they are directly related to the usability and safety of the robot. Passivity is one of the most widely used and effective criteria to assess stability of the control system especially when interaction with a dynamic environment including humans is involved. The net energy exchange in the system can be used to assess passivity of the system. Additionally, stability can also be assessed using an analytical approach that can analyze the system using symbolic calculations without any parameters substituted. From this analysis, a general relationship between the parameters in the system can be obtained and components that affect the system can be identified. Additionally, the general criteria for collocated and non-collocated control architectures can be provided to ensure passivity and stability. The passivity analysis can be conducted to identify criteria of robustness between robot and human limb. The passivity analysis can analyze the internal property of the system, while the stability analysis is the property of the system with respect to external input. Thus, the passivity of the proposed collocated control method was evaluated to establish stability and compare it with a non-collocated control architecture based on the reference signal and output of the human limb.

A. Passivity Criteria: Collocated Contral vs. Non-Collocated Control

Passivity Criteria of Collocated Control: For the collocated control architecture, a proportional-derivative current control law is considered:

C_{I}=kₚᵢ+k_{di}s, (19)

where kₚᵢ and k_{di} are positive constants. The impedance G(s) at the human-robot interaction port (τ, \dot{θ}_{H}) can be computed as:

− [symbol] =G_{col}\dot{θ}_{H}, (20)

where

$${G}_{col} = \frac{n ( s )}{d ( s )} .$$

In the case sI(s)=k_{d}, then:

$$Re [ {G}_{col} ( j ω ) ] = \frac{{a}_{1} {ω}^{2} + {a}_{0}}{d ( ω )} where \qquad ( 21 )$$

$${a}_{1} = {k}^{2} {{n}^{2} ( k - {k}_{d} )}^{2} ( {L}^{2} {b}_{m} - {J}_{m} {Lk}_{pi} + {J}_{m} {Rk}_{di} + {Lb}_{m} {k}_{di} )$$

$${a}_{0} = {k}^{2} ( k - {k}_{d} ) ( {R}^{2} {b}_{m} {kn}^{2} - {R}^{2} {b}_{m} {k}_{d} {n}^{2} - {Lkk}_{d} {k}_{pi} + {Rkk}_{d} {k}_{di} + {Rb}_{m} {kk}_{pi} {n}^{2} - {Rb}_{m} {k}_{d} {k}_{pi} {n}^{2} + {Rkk}_{b} {k}_{t} {n}^{2} - {Rk}_{b} {k}_{d} {k}_{t} {n}^{2} + {kk}_{b} {k}_{pi} {k}_{t} {n}^{2} - {k}_{b} {k}_{d} {k}_{pi} {k}_{t} {n}^{2} )$$

To make the system passive, then Re[G_{col}(jω)]≥0. This is equivalent to requiring a₁≥0 and a₀≥0.

Passivity Criteria of Non-collocated Control: For the non-collocated control case, proportional-derivative torque and current control laws are considered:

C_{T}=kₚₜ+k_{dt}s, (22)

C_{I}=kₚᵢ+k_{di}s, (23)

where kₚₜ, k_{dt}, kₚᵢ, and k_{di} are positive constants. The impedance G_{nc}(s) at the human-robot interaction port (τ, \dot{θ}_{H}) can be computed as

$$- τ = {G}_{nc} {\dot{θ}}_{H} , \qquad ( 24 )$$

$${G}_{nc} ( s ) = \frac{n ( s )}{d ( s )} . \qquad ( 25 )$$

In the case sI(s)=k_{d}, then:

$$Re [ {G}_{nc} ( j ω ) ] = \frac{{a}_{2} {ω}^{4} + {a}_{1} {ω}^{2} + {a}_{0}}{d ( ω )} where \qquad ( 26 )$$

$${a}_{2} = {b}_{d} {kk}_{di} {k}_{pt} + {b}_{d} {kk}_{dt} {k}_{pi} + {kk}_{d} {k}_{di} {k}_{dt}$$

$${a}_{1} = {b}_{d} {kk}_{pi} {k}_{pt} + {kk}_{d} {k}_{di} {k}_{pt} + {kk}_{d} {k}_{dt} {k}_{pi}$$

$${a}_{0} = {kk}_{d} {k}_{pi} {k}_{pt} .$$

To make the system passive, we need to have Re[G_{nc}(jω)]≥0. This is equivalent to requiring a₂≥0, a₁≥0, and a₀≥0.

Analysis results: The passivity analysis results mean that for both collocated and non-collocated control, the rendered stiffness needs to be lower than the stiffness of the connection. However, non-collocated SEA rely on the soft spring to achieve compliance while collocated control with QDD doesn't rely on the stiffness of the connection but the compliant actuator. Since SEA use relatively soft spring, the stiffness it can render is hence limited.

B. Stability Criteria: Collocated Contral vs. Non-Collocated Control

Stability Criteria of Collocated Control: The transfer function between the input θ_{h,r} and output θ_{H} of the collocated control architecture can be given by:

$$\begin{matrix}{G}_{e} ( s ) = \frac{{θ}_{H} ( s )}{{θ}_{h , r} ( s )} \\ = \frac{{a}_{2} {s}^{2} + {a}_{1} s + {a}_{0}}{{b}_{5} {s}^{5} + {b}_{4} {s}^{4} + {b}_{3} {s}^{3} + {b}_{2} {s}^{2} + {b}_{1} s + {b}_{0}} ,\end{matrix} \qquad ( 27 )$$

$$where {a}_{2} = {b}_{d} {k}^{2} {k}_{di}$$

$${a}_{1} = {k}^{2} {k}_{d} {k}_{di} + {b}_{d} {k}^{2} {k}_{pi}$$

$${a}_{0} = {k}^{2} {k}_{d} {k}_{pi}$$

$${b}_{5} = {J}_{h} {J}_{m} L {n}^{2}$$

$${b}_{4} = {J}_{h} {J}_{m} {Rn}^{2} + {J}_{h} {Lb}_{m} {n}^{2} + {J}_{m} {Lb}_{h} {n}^{2}$$

$${b}_{3} = {J}_{h} Lk + {J}_{h} {kk}_{D} i + {J}_{h} {Rb}_{m} {n}^{2} + {J}_{m} {Rb}_{b} {n}^{2} + {J}_{m} {Lkn}^{2} + {J}_{m} {Lk}_{h} {n}^{2} + {Lb}_{h} {b}_{m} {n}^{2} + {J}_{h} {k}_{b} {k}_{t} {n}^{2}$$

$${b}_{2} = {J}_{h} Rk + {Lb}_{h} k + {J}_{h} {kk}_{Pi} + {b}_{h} {kk}_{Di} + {J}_{m} {Rkn}^{2} + {J}_{m} {Rk}_{h} {n}^{2} + {Rb}_{h} {b}_{m} {n}^{2} + {Lb}_{m} {kn}^{2} + {Lb}_{m} {k}_{h} {n}^{2} + {b}_{h} {k}_{b} {k}_{t} {n}^{2}$$

$${b}_{1} = {Rb}_{h} k + {Lkk}_{h} + {b}_{h} {kk}_{P} i + {kk}_{D} {ik}_{h} + {Rb}_{m} {kn}^{2} + {Rb}_{m} {k}_{h} {n}^{2} + {kk}_{b} {k}_{t} {n}^{2} + {k}_{b} {k}_{h} {k}_{t} {n}^{2}$$

$${b}_{0} = {Rkk}_{h} + {kk}_{Pi} {k}_{h} .$$

The stability criteria can be obtained using Routh-Hurwitz stability criterion. For a fifth-degree polynomial:

D(s)=b₅s^{t}+b₄s⁴+b₃s³+b₂s²+b₁s+b₀, (28)

if all the elements in the first column of the Routh table are positive, then the system is stable. The first column of the Routh table is composed of b₅, b₄.

$${f}_{1} = \frac{{b}_{3} {b}_{4} - {b}_{2} {b}_{5}}{{b}_{4}} \qquad ( 29 )$$

$${f}_{2} = \frac{{b}_{5} {b}_{2}^{2} - {b}_{3} {b}_{2} {b}_{4} + {b}_{1} {b}_{4}^{2} - {b}_{0} {b}_{5} {b}_{4}}{{b}_{2} {b}_{5} - {b}_{3} {b}_{4}} \qquad ( 30 )$$

$${f}_{3} = \frac{A}{{b}_{5} {b}_{2}^{2} - {b}_{3} {b}_{2} {b}_{4} + {b}_{1} {b}_{4}^{2} - {b}_{0} {b}_{5} {b}_{4}} , \qquad ( 31 )$$

where A is

A=b₀²b₅²−2b₀b₁b₄b₅−b₀b₂b₃b₅+b₀b₃²b₄+b₁²b₄²+b₁b₂²b₅−b₁b₂b₃b₄ (32)

and b₀. To ensure the stability of the system, all six values need to be positive, i.e., b₅>0, b₄>0, f₁>0, f₂>0, f₃>0, and b₀>0. The six inequalities together compose the necessary and sufficient conditions of the system's stability.

It can be seen that the first and second inequalities are satisfied since Jₘ>0, R>0, L>0, and n>0. The last inequality can also be easily satisfied if k_{d}<k. This condition represents the desired stiffness of the system cannot be larger than the stiffness of the connection between the wearable robot and human. The third and fourth conditions are much more complicated due to the complex model that incorporates the details of the mechatronic system. However, this is not a problem in practice for two major reasons: (1) the stability conditions can be validated with a simple computer script by substituting all the parameters into the inequalities; (2) most of the parameters don't vary a lot in the design and analysis process, for example, L, R, k_{b}, kₜ, k. Most of these parameters rely on the material and manufacturing techniques. Once all the parameters are determined, the stability of the overall system can be easily analyzed with a computer script.

If L and R are assumed to be constants, then the value of Jₘ and n can affect the location of the poles. From Vieta's formulas, it is known that for larger Jₘ or n, the low-degree coefficients are smaller. This means the real part of the poles are generally closer to the imaginary axis. For a stable system, this means the input signal will decay slower, which also means the system is not robust to unmodeled dynamics and noises. This is the effect of the moment of inertia and gear ratio on the stability of the overall system.

Stability Criteria of Non-collocated Control: Similar to the collocated control architecture, the transfer function between the input and output of the non-collocated control architecture, can be given by:

$$\begin{matrix}{G}_{nc} ( S ) = \frac{{θ}_{H} ( s )}{{θ}_{h , r} ( S )} \\ = \frac{{a}_{3} {s}^{3} + {a}_{2} {s}^{2} + {a}_{1} s + {a}_{0}}{{b}_{5} {s}^{5} + {b}_{4} {s}^{4} + {b}_{3} {s}^{3} + {b}_{2} {s}^{2} + {b}_{1} s + {b}_{0}} ,\end{matrix} \qquad ( 33 )$$

$$where {a}_{3} = {b}_{d} {kk}_{di} {k}_{dt}$$

$${a}_{2} = {b}_{d} {kk}_{di} {k}_{pt} + {b}_{d} {kk}_{dt} {k}_{pi} + {kk}_{d} {k}_{di} {k}_{dt}$$

$${a}_{1} = {b}_{d} {kk}_{pi} {k}_{pt} + {kk}_{d} {k}_{di} {k}_{pt} + {kk}_{d} {k}_{dt} {k}_{pi}$$

$${a}_{0} = {kk}_{d} {k}_{pi} {k}_{pt}$$

$${b}_{5} = {J}_{h} {J}_{m} L {n}^{2} + {J}_{h} {J}_{m} {k}_{di} {n}^{2}$$

$${b}_{4} = {J}_{h} {J}_{m} {Rn}^{2} + {J}_{h} {Lb}_{m} {n}^{2} + {J}_{m} {Lb}_{h} {n}^{2} + {J}_{h} {J}_{m} {k}_{pi} {n}^{2} + {J}_{h} {b}_{m} {k}_{di} {n}^{2} + {J}_{m} {b}_{h} {k}_{di} {n}^{2} + {J}_{h} {kk}_{di} {k}_{dt}$$

$${b}_{3} = {J}_{h} Lk + {J}_{h} {kk}_{di} + {b}_{d} {kk}_{di} {k}_{dt} + {b}_{h} {kk}_{di} {k}_{dt} + {J}_{h} {Rb}_{m} {n}^{2} + {J}_{m} {Rb}_{h} {n}^{2} + {J}_{m} {Lkn}^{2} + {J}_{m} {Lk}_{h} {n}^{2} + {Lb}_{h} {b}_{m} {n}^{2} + {J}_{h} {b}_{m} {k}_{pi} {n}^{2} + {J}_{m} {b}_{h} {k}_{pi} {n}^{2} + {J}_{m} {kk}_{di} {n}^{2} + {J}_{m} {k}_{di} {k}_{h} {n}^{2} + {J}_{h} {k}_{b} {k}_{t} {n}^{2} + {b}_{h} {b}_{m} {k}_{di} {n}^{2} + {J}_{h} {kk}_{di} {k}_{pt} + {J}_{h} {kk}_{dt} {k}_{pi}$$

$${b}_{2} = {J}_{h} Rk + {Lb}_{h} k + {J}_{h} {kk}_{p} i + {b}_{h} {kk}_{d} i + {b}_{d} {kk}_{d} {ik}_{p} t + {b}_{d} {kk}_{d} {tk}_{p} i + {b}_{h} {kk}_{d} {ik}_{p} t + {b}_{h} {kk}_{d} {tk}_{p} i + {kk}_{d} {k}_{d} {ik}_{d} t + {kk}_{d} {ik}_{d} {tk}_{h} + {J}_{m} {Rkn}^{2} + {J}_{m} {Rk}_{h} {n}^{2} + {Rb}_{h} {b}_{m} {n}^{2} {Lb}_{m} {kn}^{2} + {Lb}_{m} {k}_{h} {n}^{2} + {J}_{m} {kk}_{p} {in}^{2} + {J}_{m} {k}_{h} {k}_{p} {in}^{2} + {b}_{h} {b}_{m} {k}_{p} {in}^{2} + {b}_{m} {kk}_{d} {in}^{2} + {b}_{m} {k}_{d} {ik}_{h} {n}^{2} + {b}_{h} {k}_{b} {k}_{t} {n}^{2} + {J}_{h} {kk}_{pi} {k}_{pt}$$

$${b}_{1} = {Rb}_{h} k + {Lkk}_{h} + {b}_{h} {kk}_{pi} + {kk}_{di} {k}_{h} + {b}_{d} {kk}_{pi} {k}_{pt} + {b}_{h} {kk}_{pi} {k}_{pt} + {kk}_{d} {k}_{di} {k}_{pt} + {kk}_{d} {k}_{dt} {k}_{pi} + {kk}_{di} {k}_{h} {k}_{pt} + {kk}_{dt} {k}_{h} {k}_{pi} + {Rb}_{m} {kn}^{2} + {Rb}_{m} {k}_{h} {n}^{2} + {b}_{m} {kk}_{pi} {n}^{2} + {b}_{m} {k}_{h} {k}_{pi} {n}^{2} + {kk}_{b} {k}_{t} {n}^{2} + {k}_{b} {k}_{h} {k}_{t} {n}^{2}$$

$${b}_{0} = {Rkk}_{h} + {kk}_{h} {k}_{pi} + {kk}_{d} {k}_{pi} {k}_{pt} + {kk}_{h} {k}_{pi} {k}_{pt} .$$

Similarly, the stability criteria of the non-collocated control architecture can be acquired by:

$${b}_{5} > 0 , \qquad ( 34 )$$

$${b}_{4} > 0 , \qquad ( 35 )$$

$${f}_{1} = \frac{{b}_{3} {b}_{4} - {b}_{2} {b}_{5}}{{b}_{4}} > 0 , \qquad ( 36 )$$

$${f}_{2} = \frac{{b}_{5} {b}_{2}^{2} - {b}_{3} {b}_{2} {b}_{4} + {b}_{1} {b}_{4}^{2} - {b}_{0} {b}_{5} {b}_{4}}{{b}_{2} {b}_{5} - {b}_{3} {b}_{4}} > 0 , \qquad ( 37 )$$

$${f}_{3} = ( {b}_{0}^{2} {b}_{5}^{2} - 2 {b}_{0} {b}_{1} {b}_{4} {b}_{5} - {b}_{0} {b}_{2} {b}_{3} {b}_{5} + {b}_{0} {b}_{3}^{2} {b}_{4} + {b}_{1}^{2} {b}_{4}^{2} + {b}_{1} {b}_{2}^{2} {b}_{5} - {b}_{1} {b}_{2} {b}_{3} {b}_{4} ) / ( {b}_{5} {b}_{2}^{2} - {b}_{3} {b}_{2} {b}_{4} + {b}_{1} {b}_{4}^{2} - {b}_{0} {b}_{5} {b}_{4} ) > 0 , \qquad ( 38 )$$

$${b}_{0} > 0. \qquad ( 39 )$$

It can be seen that the first and second inequalities are satisfied since Jₘ>0, R>0, L>0, and n>0. The last inequality can also be easily satisfied if k_{d}<k. This condition represents the desired stiffness of the system cannot be larger than the stiffness of the connection between the wearable robot and human.

Results of Stability Analysis: Based on the analytical analysis about collocated and non-collocated system, the factors may significantly affect the control system stability. A numerical-based analysis was conducted to study the effects of the parameters on the system performance by engaging the control variates method. Some parameters of the wearable robot design were controlled and how the other varying factors affect the system performance were observed. This method allowed for the identification of factors that lead to the most significant changes to the system, which can be beneficial to the hardware design and system assessment without requiring a large workload and cost.

C. Criteria for System Stability and Passivity

The advantage of collocated control is its stability and robustness to unmodeled dynamics and external disturbances even without a loadcell. For the non-collocated control case with a loadcell, the stability can be guaranteed when the parameters are close to the heuristic system design. For the non-collocated control case without a torque sensor, stability cannot always be guaranteed. The capability of the system to carry out the commanded torque is limited. The bandwidth is relatively low with the same parameters. Generally, the collocated control approach permits a wider range of desired impedance in terms of stiffness and damping, which can assist in more agile human activities than normal walking. Specifically, with collocated control, the system can track the reference torque signal well with a large range of impedance. The non-collocated control, however, cannot provide a good tracking error of the torque profile with low impedance values. Thus, a collocated control approach is desired since it allows the wearable robot to simulate a wider range of impedance, especially low impedance values, which is an important point in wearable robots since it is necessary to prevent human wearers from injuries.

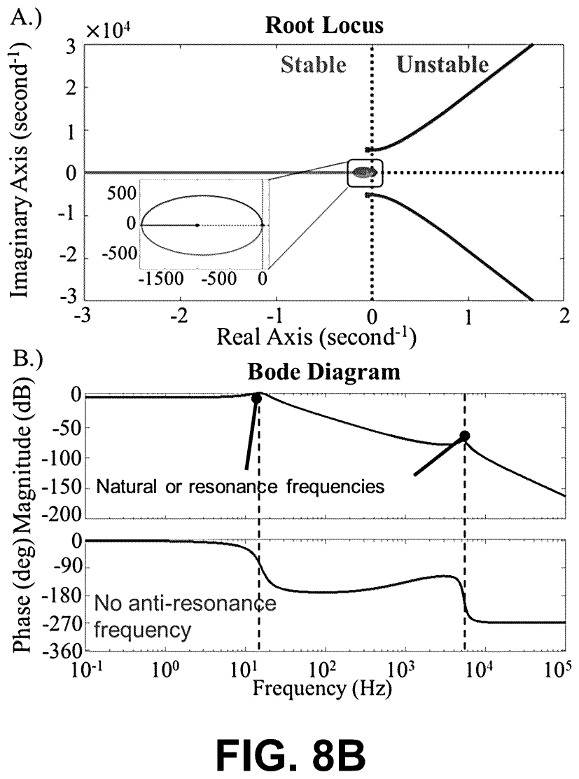

Comparison of control architectures: The difference of the two control architectures is reflected in the root locus plots regarding the impedance and specifically the stiffness it can render. FIG. 8A illustrates an example of the root locus and bode diagram of the collocated control of QDD and FIG. 8B illustrates an example of the root locus and bode diagram of the non-collocated control of SEA. The collocated control can render a much larger range of desired impedance. Both architectures need to satisfy the condition that the desired impedance should not be larger than the stiffness of the connection component. Since SEA-based robot relies on the spring between actuator and human joint to achieve compliance, and QDD-based robot relies on the low gear ratio motor to achieve compliance, so the connection between actuator and human joint doesn't need to be as compliant as a spring. This can greatly extend the range of the desired impedance with high-stiffness connections.

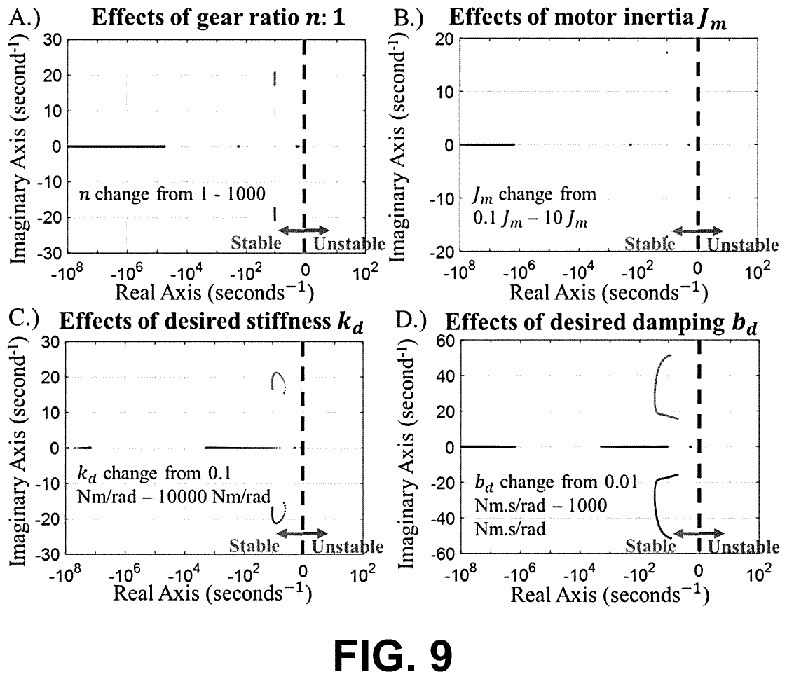

Effects of system parameters: The system parameters can significantly affect the system performance in terms of stability and many other aspects. In FIG. 9, the effects of different system parameters on the closed-loop system poles of the transfer function are illustrated. It can be seen that for collocated control, for the parameters selected, they change the location of the closed-loop pole significantly, but all the poles are on the left side of the s-plane. This means that these parameters can affect the system performance but will not lead the system to an unstable situation. This reflects the merit of the collocated control approach, which gives the design and control more options such that compromises between factors do not hinder the system's safety.

### Experimental Evaluation

To characterize the proposed estimation method and evaluate the controller performance, both benchtop experiments and human trials were conducted. The experiments were conducted with two healthy subjects. The subjects were able to execute complete flexion and extension movements of the knee joint with neither spasticity nor contracture. All subjects were informed of the experimental protocols and gave their consent before participating in the experiments. Constraints on the knee joint position, velocity, and acceleration were imposed, and the security of the range of motion between full extension (90°) and full flexion (30°) was ensured mechanically using mechanical joint limiters. All precautions were taken to not adversely affect the health of the participants who served as research subjects. Model validation was conducted to verify the accuracy of the modeling, torque estimation accuracy experiments were conducted, stability evaluation was conducted, and impedance tracking were conducted with a QDD (gear ratio=6:1) actuator-based knee exoskeleton.

FIG. 10 illustrates the experimental setup. A QDD actuator-based knee exoskeleton design was utilized as shown in FIG. 10. The exoskeleton comprises of a torque sensor to provide torque feedback to improve tracking and stability of the control system. However, using QDD actuators allows for estimating the output torque based on the current drawn by the actuator. By leveraging the directly proportional relationship between the output torque and current times motor's torque constant, the previous exoskeleton design was improved on by removing the torque sensor and consequently reducing the overall weight and complexity of the exoskeleton. Moreover, eliminating the torque sensor also lowered the overall cost of the exoskeleton. This would not be possible with conventional actuators and SEAs due to multiple complex dynamic effects, such as friction, backlash, and vibrations, that highly influence the output torque's relationship with input current. The proposed torque estimation solution further improves on the current estimation method by providing better stability and accuracy. Experiments were done on the actuator to check the stability and accuracy of our torque estimation method. Images of the benchtop test of the actuator and exoskeleton robot test are shown in FIG. 10. During benchtop experiments a loadcell was used as a torque sensor for evaluation purposes only and not to control the exoskeleton. The actuator was held in place using vice grips that are clamped down on the metal end pieces. Whereas, to test the method in real world scenarios, human subject experiments were done where they would walk and run on a treadmill while wearing the exoskeleton.

### A. Evaluation of Wearable Robot Modeling

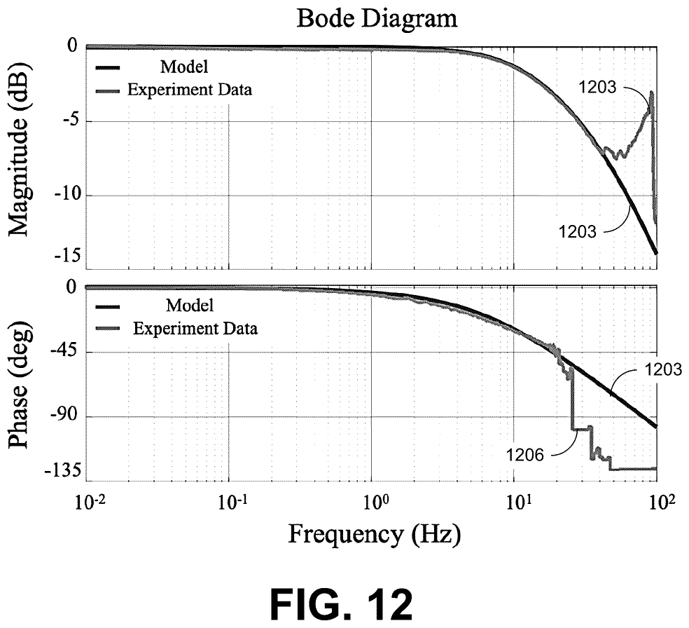

The interaction between the wearable robot interacting the human limb was modeled, and torque estimation analysis and stability analysis were conducted to verify the accuracy of the modeling. Based on open-loop block diagram as shown in FIG. 11, the open-loop transfer function from τᵣ to τₐ can be written as:

$${G}_{R} ( s ) = \frac{{τ}_{a} ( s )}{{τ}_{r} ( s )} = \frac{{kk}_{I} + {kk}_{P} s}{{a}_{4} {s}^{4} + {a}_{3} {s}^{3} + {a}_{2} {s}^{2} + {a}_{1} s + {kk}_{i}} , \qquad ( 40 )$$

$$where {a}_{4} = {J}_{m} L {n}^{2} \qquad ( 41 )$$

$${a}_{3} = {J}_{m} {Rn}^{2} + {Lb}_{m} {n}^{2} + {J}_{m} {k}_{p} {n}^{2}$$

$${a}_{2} = Lk + {k}_{b} {k}_{t} {n}^{2} + {Rb}_{m} {n}^{2} + {J}_{m} {k}_{i} {n}^{2} + {b}_{m} {k}_{p} {n}^{2}$$

$${a}_{1} = {b}_{m} {k}_{i} {n}^{2} + Rk + {kk}_{p}$$

Substituting the system parameters shown in Table I of FIG. 6 and the parameters for the current controller with k_{I}=0.22 and k_{P}=22 into Eq. (40), yields:

$${G}_{R} ( s ) = \frac{500 s + 50 s}{6.77 \times {10}^{- 7} {s}^{4} + 0.02 {s}^{3} + 16.61 {s}^{2} + 559.4 s + 50} . \qquad ( 42 )$$

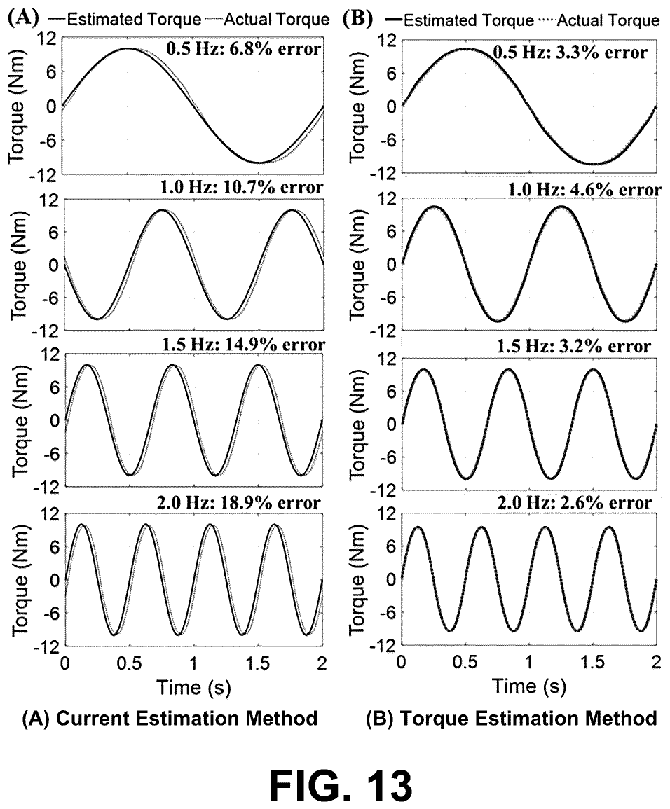

The bode plot illustrating the magnitude and phase response is shown by the model curve 1203 in FIG. 12. To verify the accuracy of model curve, the open-loop frequency response for the exoskeleton was also tested with a sinusoidal chirp reference from 0.01 Hz to 100 Hz. From FIG. 12, it can be observed that the real-time response (data curve 1206) closely follows the model's response (curve 1203) from 0.01 Hz to 40 Hz in magnitude plot and from 0.01 Hz to 20 Hz in phase plot. At higher frequencies, since the gains are low, τₐ is highly influenced by the noise and the encoder resolution which led to minor disturbances in real-time response observed in FIG. 12. Based on the comparison between theoretical and experimental results, it is demonstrated that the proposed wearable robot model emulates the performance of the system with higher accuracy.

### B. Accuracy of Torque Estimation

Actuator Evaluation Results: For an exoskeleton to work in parallel with the wearer, the exoskeleton should be able to accurately generate assistive torque of the right magnitude at the right time. To validate the accuracy of the torque estimation method in an ideal situation, the actuator was held in place with vice clamps to simulate a perfectly fitted condition of the worn exoskeleton while a sine wave signal was passed to it. To simulate the human knee angle, θ_{h,r}, over a gait cycle at different speeds as an input, four sine wave command signals were sent at 4 different frequencies (0.5 Hz, 1.0 Hz, 1.5 Hz, and 2.0 Hz). The objective was to estimate torque using the proposed method and quantify its similarity with the actual torque measured by the loadcell. The tracking performance at each frequency was evaluated using the root mean square error (RMSE) between the torque estimated and the actual torque measured. Furthermore, to establish the superior performance of the method over alternative method the same process was repeated using the current based torque estimation method.

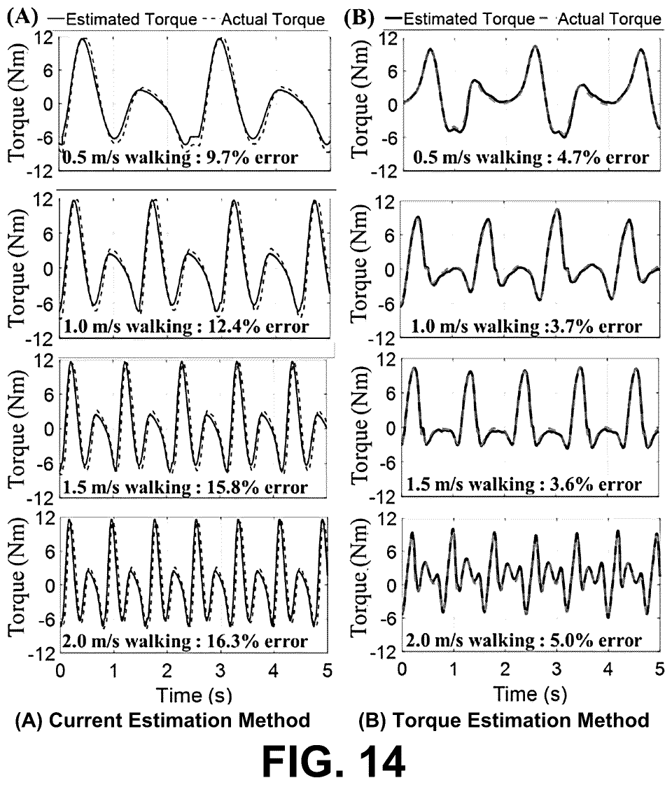

The results of the experiment are shown in FIG. 13 where the left column (A) illustrates estimation accuracy using the current based torque estimation method and the right column (B) illustrates estimation accuracy using the torque estimation method. The actuator was given a sine wave command signal to simulate the human knee angle over a gait cycle. The solid line is the estimated torque and the dotted line is the actual torque produced by the actuator. The RMSE for all four speeds were below 0.6 with the lowest RMSE being 0.3538 Nm at 1.5 Hz and an average RMSE of 0.428 Nm. To provide a better assistance to the wearer, the assistive torque should be able to be provide a proper ratio of biological torque. When factoring the peak torque for each speed, the 1.0 Hz speed has the lowest RMSE per average peak percentage at 3.9081% with the average peak torque of 9.5 Nm. The current based estimation method was assessed using both filtered and unfiltered signals. However, irrespective of being filtered or unfiltered the average peak torque was 11.5 Nm. With the average peak torque staying constant throughout the different speeds, the RMSE per average peak percentage was directly proportional to the RMSE. The RMSE increased with speed regardless of whether the current signals were filtered or not. Generally, the error would increase with the speed as observed for the current based estimator. The proposed torque estimation method, although showing a similar upward trend with increased speed, had a lower RMSE. Thus, the results affirm that the proposed torque estimation method can perform better than the current based torque estimation method.

Wearable Robot Evaluation Results: Experiments were also conducted with two healthy subjects to validate the performance of the proposed method in a dynamic environment under real-world human robot interaction. The exoskeleton was used in a bi-lateral configuration with the actuators mounted in parallel with the subject's knees via 3D printed braces, Velcro straps, elastic bands, and a waist band. The subject also wore a pair of insoles in their shoes to measure their gait cycle, since the input, human knee reference angle θ_{h,r}, is depended on the gait percentage of the subjects. The subjects were asked to walk at four different speeds (0.5 m/s, 1.0 m/s, 1.5 m/s and 2.0 m/s) on a flat treadmill. The objective was to quantify the accuracy with which the actuator estimated assistive torque compared to the actual assistive torque measured by the loadcell.

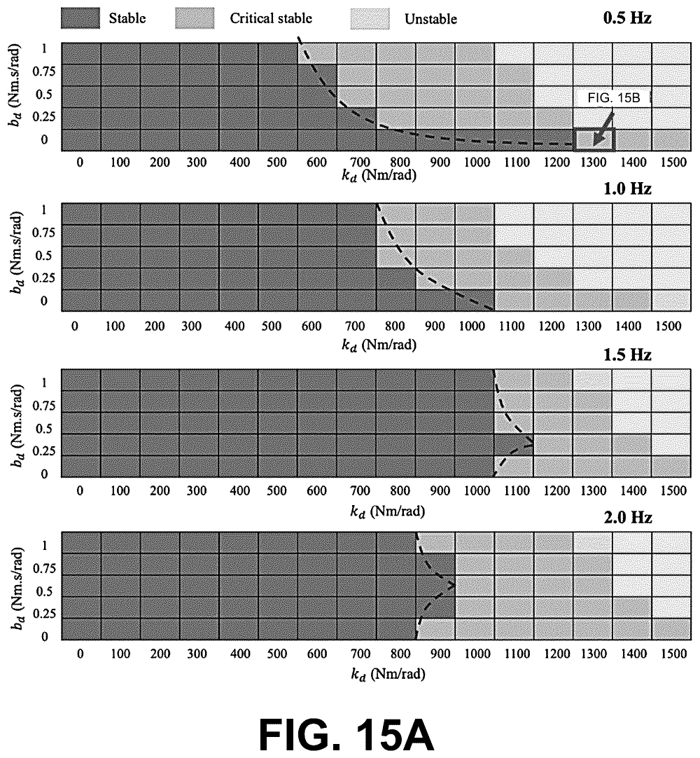

The powered walking results using the current based torque estimation control compared to the proposed torque estimation method control are shown in the left column (A) and the right column (B) of FIG. 14, respectively. The plots show the human-exoskeleton torque estimation results comparing the estimated and actual torque provided over a five second interval. The solid line is the estimated torque, and the dotted line is the actual torque produced by the actuator. The results showed that the average RMSE for all four speeds using the torque estimation method is 0.422 Nm while the current method had a higher average RSME of 1.500 Nm. Therefore, using the proposed torque estimation method lowered the RSME by 71.8667%. Similar to the benchtop experiments, the error increased as the subjects increased their speeds using the current based torque estimation method, the error also increase when the subjects increase the speeds using the torque estimation method, but the error remained closer to the average throughout all four speeds. This illustrates that the proposed method has a high torque tracking accuracy compared to the commonly used state-of-the-art current based estimation method.

### C. Stability Evaluation

In a real-world scenario, the wearer performs various activities of daily living tasks that utilize varying stiffness and damping on the actuator control system. This means that the actuator needs to render a large range of stiffness and damping. To test the actuator's stability when given different stiffness and damping values, the actuator was secured to the benchtop table using vice clamps. The experiment was performed using only one actuator since human testing can induce external unknown movements and is not safe for the subject when the actuator becomes unstable. Each testing region included a combination of a known maximum desired stiffness, k_{d} and maximum desired damping, b_{d} value and were commanded using a sine wave of 4 different frequencies (0.5, 1.0, 1.5, and 2.0 Hz). The gain of the command signal was increased gradually for each k_{d} and b_{d} value.

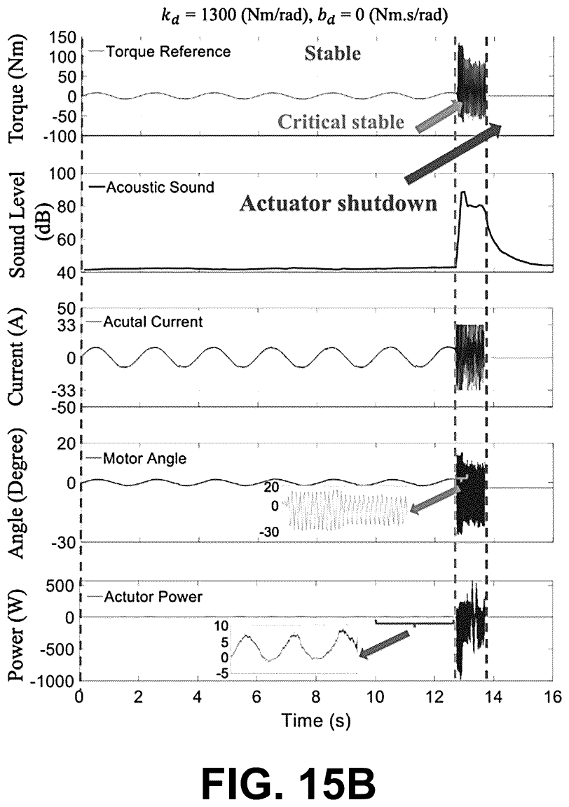

The actuator would be stable if the torque command can be tracked with minor error and would be critical stable when the actuator shows unexpected dynamics such as high frequency chattering and vibrations. Each frequency was tested with increasing k_{d} while keeping b_{d} constant until the actuator became critical stable and then repeated the test with increasing the b_{d} value and keeping the k_{d} value the same. The transition from stable to critical stable can be seen in FIG. 15A. The transition occurs at k_{d}=1300 b_{d}=0 as the gain increases from 0.9 to 1.0. The reference torque reference rapidly which in turn causes the actuator to produce a high sound and pulls current irregularly (rapid change). Due to the rapidly changing angle position, the angular velocity would also spike causing the actuator power to spike as well.

The stability results can be seen in FIG. 15A where each cell represents a stability region that was tested. The darkest cells (left) represent the stable regions where the k _{d} and b_{d} values can be rendered stable while the lighter cells show the region of k_{d} and b_{d} values that would cause the actuator to become critical stable when the gain increases from 0.9 to 1.0. Lastly, the lightest cells (upper right) represent the unstable region (actuator shutdown) where the actuator cannot render the torque reference when increasing the gain from 0.0 to 0.1. FIG. 15B illustrates an example of the experimental stability results. The dashed lines show the border where the response transitions from stable to critical stable. The trend shown in FIG. 15B closely matches the theoretical results in the root locus plot. The stability results of the method validate the ability to support high bandwidth range for stiffness and damping where the stiffness can achieve 1000 Nm/rad and above with no damping.

A novel collocated impedance control method has been presented that can achieve continuous torque assistance based on proprioceptive QDD actuators of a knee exoskeleton. The proposed combination of QDD collocated actuation and control strategy can achieve accurate torque estimation without any torque sensors providing feedback, resulting in high accuracy, extensive stability region, lightweight and cost-effective wearable robots. The proposed control provides an alternative torque estimation method for collocated QDD exoskeletons instead of using torque sensors or elastic elements. Presented modeling and analysis demonstrate the advantages of QDD actuation method compared with the SEA actuation method. It also presents a control method which shows higher accuracy and stability compared to the traditional current-based control method which is verified both in theory analysis and human treadmill walking experiments.

The evaluation of the robot modeling accuracy using bode plot, the open-loop frequency response shows that the modeling result matches the experiment result very well. It demonstrates that the robot modeling is accurate to describe the system. The benchtop actuator evaluation results and human-exoskeleton evaluation results show that the torque estimated by the method matches well with the actual torque measured by a loadcell. The average RMSEs are 0.428 for actuator and 0.422 for exoskeleton which are lower than that of current-based torque estimation method.

The theoretical analysis of stability, the root locus plots, show that the non-collocated control of SEA cannot always guarantee stability, however, it can be achieved by collocated control of QDD. The stability evaluation experimental results of the actuator also demonstrate that the QDD actuator outperforms SEA. The QDD actuator has a large stiffness bandwidth and damping ranges with 1000 Nm/rad stiffness and above.

The collocated control system is more stable than non-collocated control in the sense that it can render a larger range of desired impedance. This is important in the wearable robot design since this feature allows for more activities to be assisted by the wearable robots. The root loci indicate that for the non-collocated control scheme, due to its right half plane zeros, the root locus will extend to the right half-plane when the control gains are large. However, due to the interlacing poles and zeros, the roots of the collocated control scheme will always stay in the left halfplane.

### Collocated Torque Control of Portable Exoskeleton Without Torque Sensor: Stability Enhancement and Torque Estimation

Portable exoskeletons have the potential to assist people with gait impairments and enhance the mobility of able-bodied individuals in community settings. For exoskeletons to be used in community settings, they should be highly dynamic to meet the needs of a wide variety of human motion tasks, e.g., walking and running. Therefore, multifaceted requirements, including lightweight, high bandwidth, high back drivability, accurate torque tracking and estimation, and high stability, should be considered in the mechatronics design and control of exoskeletons.

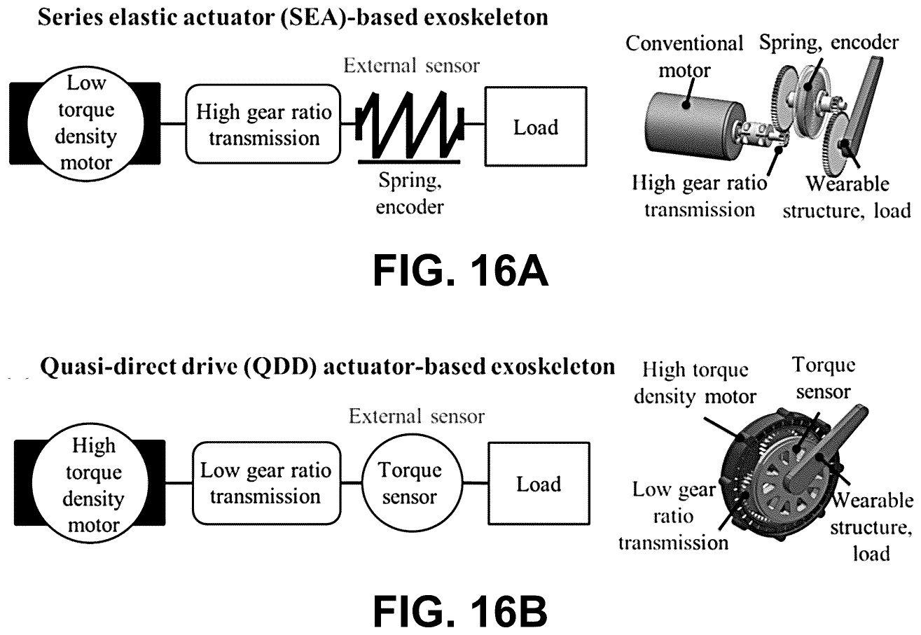

State-of-the-art exoskeletons with electric actuation typically adopt series elastic actuators (SEA) and or the increasingly popular quasi-direct drive actuators (QDD) with external torque sensors, as shown in FIG. 16A and 16B. The SEA mechanism comprises a motor with low torque density, a high gear ratio transmission, and an elastic element, typically a spring. The spring is placed between the gear train and the driven load to reduce the actuator's stiffness intentionally and allow for higher backdrivability (i.e., smaller resistive torque). The spring deflection can be measured by external sensors (encoder) and the output torque can be calculated using Hooke's laws. With the spring design, the output torque can be measured from the stiffness value multiplied by the spring deflection obtained from external sensors such as encoders. However, trade-offs between the metrics across the parameters in SEA-based exoskeleton will be made. For example, SEA compromises bandwidth to improve backdrivability by reducing spring stiffness. But higher stiffness amplifies the torque estimation error since a higher stiffness value leads to a stiffer spring, causing less spring deflection under equal force/torque than lower-stiffness springs. Furthermore, to meet conservative stability standards, SEA cannot provide a higher pure stiffness than the spring stiffness of the elastic element in the actuator. As a result, a SEA with a wide selection range of control parameters requires an elastic element with higher spring stiffness.

The QDD actuator was recently introduced to address the multifaceted requirements in exoskeletons. The QDD actuator comprises a high torque density motor and a low gear ratio transmission, as shown in FIG. 16B. It leverages external sensors (torque sensors) to provide exteroceptive feedback signals for accurate torque control. Without the spring and extra components, the QDD-based exoskeleton is more lightweight than the SEA-based unit. Previous work has demonstrated that QDD-based exoskeletons not only have both high bandwidth and high backdrivability but also can adjust a large range of stiffness electrically for versatile locomotion assistance. It differs from variable-stiffness actuators, where the stiffness is varied by introducing a second motor. However, torque sensors can be used to measure the assistive torque and provide control feedback to properly execute duties with the wearer since exoskeletons are always in contact with human limbs. The QDD-based exoskeleton can achieve highly accurate torque tracking due to the torque sensors and the low inertia and friction of the system. The addition of torque sensors, however, results in a significant cost increase (up to $1000 each) and adds extra weight (200 g-500 g per joint).

Although QDD-based exoskeletons with torque sensors in the exoskeleton can provide high backdrivability, high bandwidth, and accurate torque tracking, how to improve the stability and remove torque sensors while maintaining accurate torque estimation has been further investigated. An anti-cogging approach has been proposed to reduce torque ripples (which cause in-smooth motions) and offer precise force control for cheap direct drive (DD) motors. However, their ultra-low DD torque (peak 0.01 Nm) does not meet the requirements of exoskeleton torque (at least 10 Nm). Previous attempts to remove torque sensors employed current-based methods (or times a correction constant) to estimate the output torque of the QDD actuator. However, the estimation accuracy of these methods has not been quantified yet, and it is unclear how this method might perform in human-exoskeleton interaction with different activities, like walking and running. Furthermore, QDD exoskeletons have been newly developed in the last two to three years, so their stable performance and how to enhance their stability have not been investigated. Hence, an underlying philosophy of “sensing for control” has been proposed to corroborate QDD exoskeleton design, namely, meticulous robot sensing design technology can eliminate the need for external sensors (torque sensor and elastic elements) and improve stability while simultaneously maintaining high-fidelity assistive torque sensing.

To address challenges in exoskeletons, a unified architecture for torque-controlled exoskeletons is proposed that can be used with either SEA or QDD actuation schemes, thus providing a universal method to analyze their stability systematically. Following this architecture, three variants of collocated torque controllers (direct torque control, admittance control, and impedance control) were developed to meet the needs of strict kinetic trajectories and a balance between position and torque control. In the collocated torque control architecture, the torque estimator can achieve high-fidelity estimation and eliminate the need for a torque sensor for QDD-based exoskeletons. FIG. 16C shows a QDD actuator-based exoskeleton with the external sensors (torque sensor) removed and the output torque estimated by built-in sensors. The theoretical analysis demonstrates that the stability of the collocated QDD-based exoskeleton has a larger margin of stability than the non-collocated SEA and QDD-based exoskeletons. Experimental results establish that the collocated control architecture increases the stability region, which allows the implementation of higher joint stiffness (1200 Nm/rad) needed for human-running experiments. In addition, the torque estimator produced a significantly smaller torque estimation error (3-5%) than the current-based torque estimation methods (10-20%) across different walking and running conditions. It was found that the QDD-based exoskeleton with collocated control is better than the QDD-based exoskeleton with non-collocated control, and the QDD-based exoskeleton is better than SEA based exoskeleton in terms of stability, estimation accuracy, and cost.

### Unified Architectures of Actuation and Sensing Analysis for Torque Controlled Exoskeleton

To understand how the actuator with sensing affects the stability and control of the exoskeleton, unified architectures of torque-controlled exoskeletons are presented for different actuation paradigms with external or internal sensing, e.g., SEA with elastic elements, QDD with torque sensor, and QDD with encoder and current sensors. Depending on the placement of the sensors, the control architecture of wearable robots can be broadly classified into non-collocated control and collocated control.

### A. Non-Collocated Control Architecture: SEA and QDD Actuator-based Exoskeleton

A general architecture for powered exoskeletons generally comprises motors, transmission, sensing, and wearable structures. For existing torque-controlled exoskeletons, expensive torque sensors or bulky spring mechanisms are used. These sensing methods are used after the motor transmission to measure torque. Thus, the effects of nonlinear dynamics introduced by friction, backlash, and vibration have no effect on the measurement. This architecture, as shown in FIGS. 16A and 16B, utilizes additional sensing elements, increasing the cost and weight while also complicating the mechanical design of wearable robot actuators.

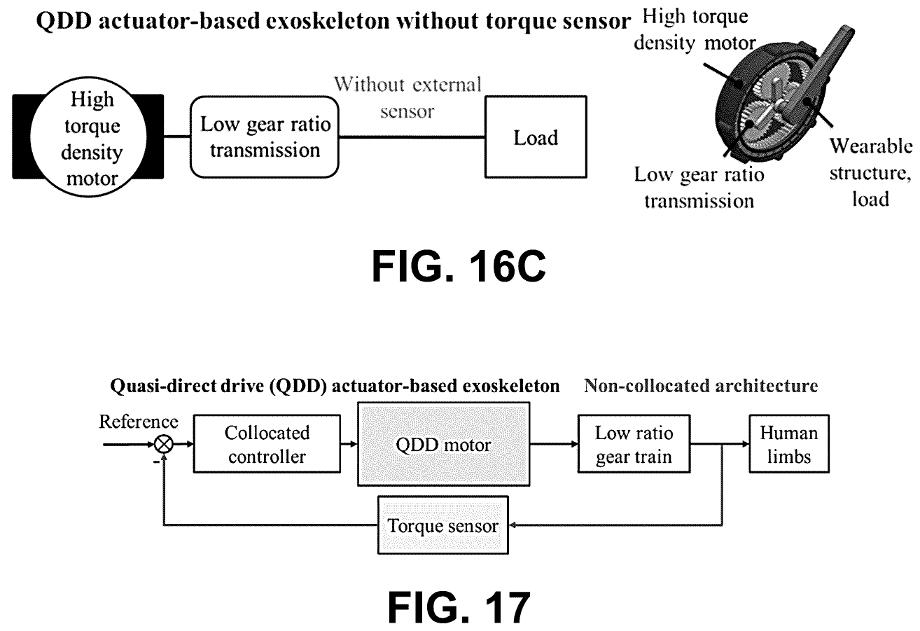

In this control architecture, the sensors and actuators are placed at different locations. FIGS. 2B and 17 show examples of non-collocated control architectures with different actuation schemes (SEA with additional spring elements and high gear ratio and QQD with torque sensors, respectively), which are used in wearable robotics. A conventional motor has a hall sensor and encoder to measure the motor current and its angular position. However, using these measurements, the torque cannot be accurately estimated after the gear due to nonlinearities such as backlash, friction, etc. Therefore, to measure the torque in SEA mechanisms, an expensive torque sensor is attached to the motor's output shaft after the transmission, or a pair of encoders is used before and after the spring. In general, non-collocated sensing is a challenging problem in robotics, as it can introduce a variety of issues, such as time delay, phase lag, and noise, that affect the performance and stability of the system.

### B. Collocated Control Architecture: QDD Actuator-based Exoskeleton

In this control architecture, the sensors and actuators are placed at the same location. FIG. 2C shows an example of collocated control architecture with QDD actuators where the embedded motor sensors (e.g., encoders and current sensors) can be used to estimate the torque. Collocated control architectures are generally more stable and robust than non-collocated control since these last lead to alternating zeros and poles near the imaginary axis. Although the employed QDD motors in the exoskeleton also have sensors that can measure only the current and the angular position, these measurements were used to estimate the torque at the motor's output shaft.

### Collocated Controller Design of QDD Actuator-Based Exoskeleton

To illustrate how to design collocated controllers for torque control-based lower limb exoskeletons, the human exoskeleton dynamical model coupled with a QDD actuator is briefly presented. Next, a generalized collocated torque control algorithm is derived using the human exoskeleton model, including collocated direct torque control and collocated indirect torque control (impedance control and admittance control). Last, the detailed procedure for the collocated impedance controller is illustrated.

A. Model of a Human Knee Exoskeleton System with QDD

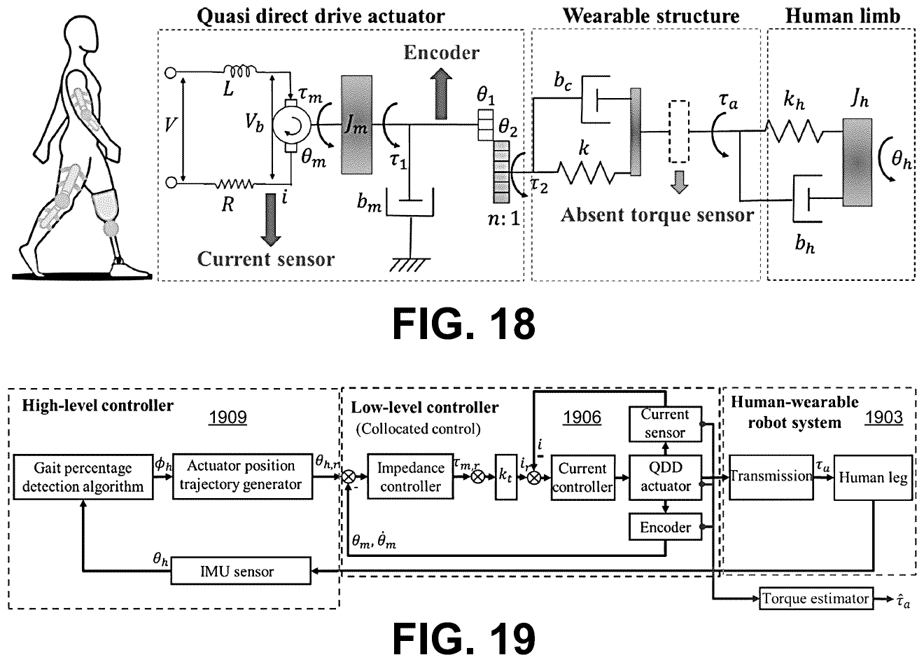

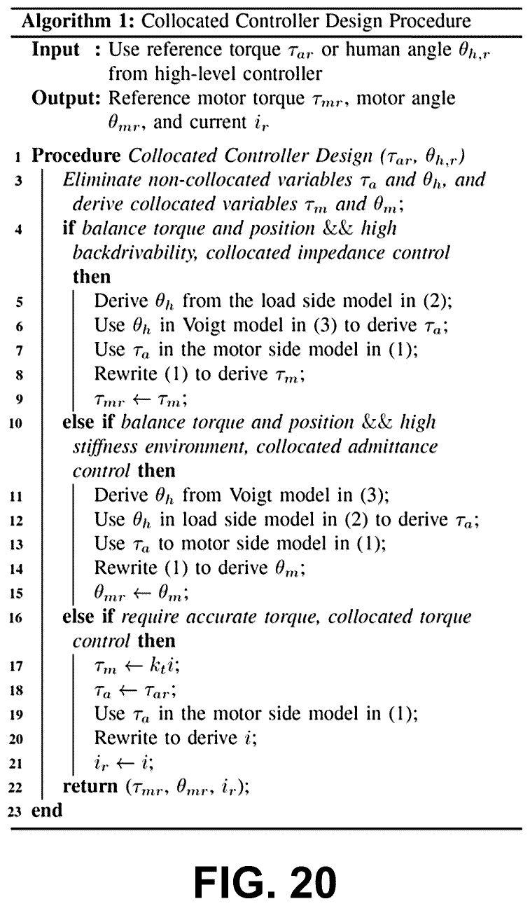

The human knee exoskeleton system comprises a QDD actuator connected to a wearable structure, which is then attached to the human limb (e.g., thigh and shank), as shown in FIG. 18. The model of the human-exoskeleton system includes the mechanical and electrical dynamics of the QDD actuator, and the wearable structure and the human limb, both modeled as a second-order linear system. FIG. 19 is a schematic block diagram illustrating an example of a wearable robot controller comprising wearable robot hardware (1903), low-level/collocated controller (1906), and high-level controller (1909). The high-level controller 1909 comprises a gait event detection algorithm that detects gait events based on wearable sensor measurements and a position trajectory generator that generates the desired human position (based on the gait events). The low-level controller 1906 regulates control effort for the actuator system to track the desired position generated by the high-level controller 1909.

Based on the mechanical model of the motor, its dynamics can be written as:

[symbol]

₂=n( [symbol] ₘ−Jₘ\ddot{θ}ₘ−bₘ\dot{θ}ₘ), (43)

where Jₘ is the motor's rotor inertia, bₘ is motor damping coefficient, θₘ is the rotor's angular position, τₘ, is the motor torque, n is the gear ratio, and τ₂ denotes the torque provided at the output shaft. Next, the wearable structure was designed using braces, straps, and rigid linkages. Model the wearable structure with a stiffness k and damping b_{c}. The torque at the output shaft of the gearbox can be given by:

[symbol]

₂=k(θ₂−θₖ)+b_{c}(\dot{θ}₂−\dot{θ}ₖ),

where θ₂ and θₖ are the gearbox's output shaft rotation angle and knee joint angle, respectively. Here k and b_{c} represent the transmission stiffness and damping coefficients, respectively. Since b_{c} is typically negligible in the wearer structure, in this work, the torque at the output shaft of the gearbox is assumed to be:

[symbol]

₂=k(θ₂−θₖ). (44)

### B. Generalized Collocated Controller Design

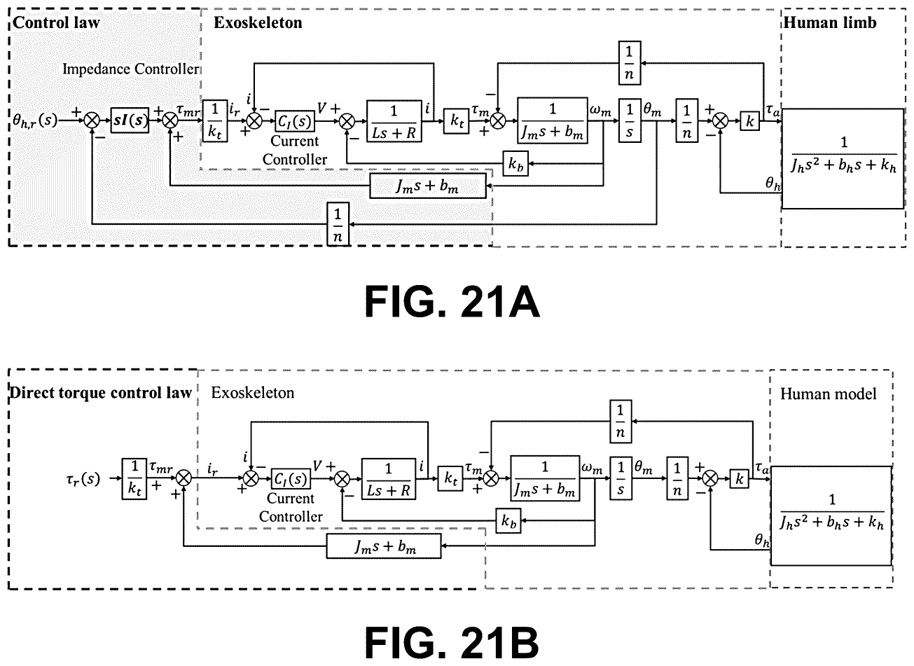

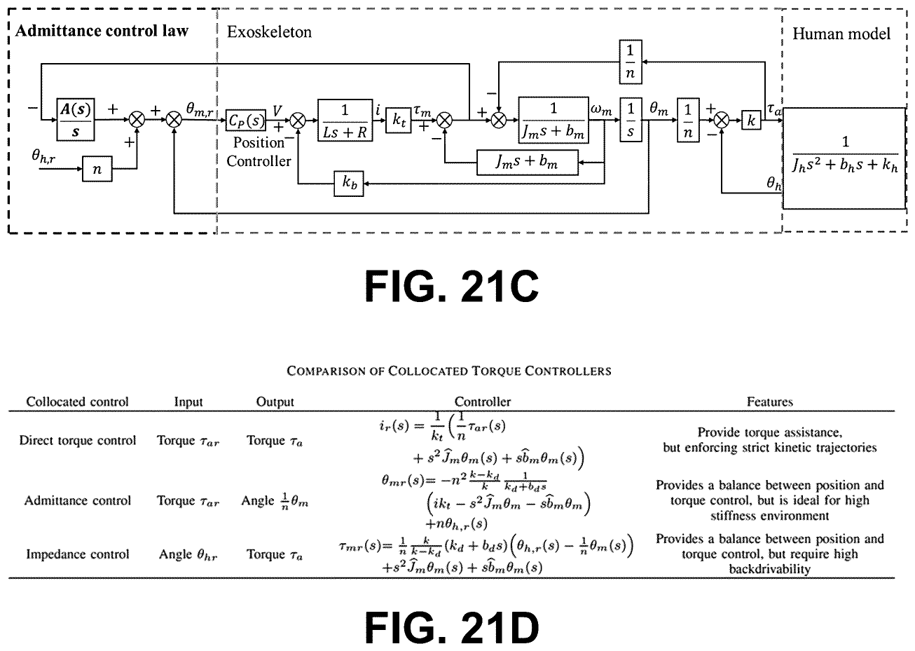

To provide assistive torque, two approaches can be utilized: 1) direct torque control and 2) indirect torque control, also known as impedance control and admittance control. FIG. 20 illustrates an algorithm (Algorithm 1) outlining an example of a step-by-step procedure to design collocated torque controls, e.g., collocated direct torque, collocated impedance, and collocated admittance control strategy. FIGS. 21A-21C illustrates examples of the three controllers and the Table of FIG. 21D compares their characteristics.

Collocated direct torque controller. The direct torque control approach tracks the desired reference torque signal to generate accurate assistive torque for the human limb. However, although this approach can generate the desired assistive torque, it is known to lack the ability to control the mechanical work exchanged between the wearable robot and its environment, leading to the possibility of generating high-impact forces. Thus, imposing stringent reference torque trajectory constraints makes the wearable robot less compliant and potentially unsafe.

Collocated indirect torque controller admittance controller and impedance controller. The indirect torque control (impedance control and admittance control) can balance torque control and position control. In general, admittance control is ideal for a higher-stiffness environment, and impedance control is ideal for a lower-stiffness environment to maximize the control performance.

The lower-limb exoskeleton can be programmed in impedance, admittance, or torque control modes. In this section, the generalized design procedure for collocated controllers is explained. Algorithm 1 of FIG. 20 outlines a step-by-step procedure to design a collocated impedance, admittance, or torque control strategy.

### C. Collocated Impedance Control

The torque at the output of the wearable structure τₐ=τ₂ is given by:

[symbol]

₂=n( [symbol] _{m,r}−Ĵₘ\ddot{θ}ₘ−\hat{b}ₘ\dot{θ}ₘ), (45)

where Ĵₘ and \hat{b}ₘ are the motor's estimated total inertia and damping coefficients, respectively. The parameters of the wearable structure were obtained through a system identification procedure. A Voigt body, comprising a virtual spring and damper connected in parallel to impose a desired impedance, was used. The desired impedance was defined as:

k_{d}(θₕ−θ_{h,r})+b_{d}(\dot{θ}ₕ−\dot{θ}_{h,r})=− [symbol] ₂, (46)

where k_{d} and b_{d} are the desired stiffness and damping parameters, respectively, and θ_{h,r} is the human knee joint reference angle. Since a collocated controller is being developed, feedback from the external sensor, such as a torque sensor or an Inertial Measurement Unit (IMU), is not used to measure τ₂ or θₕ. To avoid the need of human knee angle measurements, considering b_{c} to be negligible, it can be rewritten as:

$${θ}_{h} = \frac{1}{n} {θ}_{m} - \frac{1}{k} {τ}_{2} . \qquad ( 47 )$$

Assuming that the system response is fast, the human joint angular velocity equals the angular velocity of the motor after the gear, i.e.,

$${\dot{θ}}_{h} \approx \frac{1}{n} {\dot{θ}}_{m} . \qquad ( 48 )$$

Substituting for θₕ and \dot{θ}ₕ from Eqs. (47) and (48), respectively, in Eq. (46), and solving for τ₂, gives:

$${τ}_{2} ( s ) = \frac{k}{k - {k}_{d}} ( {k}_{d} + {b}_{d} s ) ( {θ}_{h , r} ( s ) - \frac{1}{n} {θ}_{m} ( s ) ) . \qquad ( 49 )$$

Eq. (49) represents the torque estimate at the motor's output. Notice that the torque estimator uses no external torque sensor and relies only on the motor's encoder measurements. The desired motor torque, can be obtained by taking the Laplace transform of Eq. (45), substituting τ₂ (s) from Eq. (49) in Eq. (45), and solving for τₘ, gives:

$${τ}_{m} ( s ) = sI ( s ) ( {θ}_{h , r} ( s ) - \frac{1}{n} {θ}_{m} ( s ) ) + {\hat{J}}_{m} {\ddot{θ}}_{m} + {\hat{b}}_{m} {\dot{θ}}_{m} , \qquad ( 50 )$$

$$where sI ( s ) = \frac{1}{n} \frac{k}{k - {k}_{d}} ( {k}_{d} + {b}_{d} s ) . \qquad ( 51 )$$

Eq. (51) represents the collocated impedance control law sI(s) of the QDD actuator. FIG. 21A is a block diagram of a collocated impedance controller for QDDs. Motor current i and motor angle and velocity, i.e., θₘ and \dot{θ}ₘ as feedback. The impedance controller sI(s) is given by Eq. (51), and the current controller is a PD controller. FIGS. 21B and 21C are block diagrams of a collocated direct torque controller and a collocated admittance controller for QDD-based exoskeletons. The control law for the collocated direct torque controller can be expressed as:

$${i}_{r} ( s ) = \frac{1}{{k}_{t}} ( \frac{1}{n} {τ}_{ar} ( s ) + {s}^{2} {\hat{J}}_{m} {θ}_{m} ( s ) + s {\hat{b}}_{m} {θ}_{m} ( s ) ) .$$

The control law for the collocated admittance controller can be expressed as:

$${θ}_{m , r} ( s ) = - \frac{A ( s )}{s} ( {ik}_{t} - {s}^{2} \hat{{J}_{m}} {θ}_{m} - s \hat{{b}_{m}} {θ}_{m} ) + n {θ}_{h , r} ( s )$$

$$\frac{A ( s )}{s} = {n}^{2} \frac{k - {k}_{d}}{k} \frac{1}{{k}_{d} + {b}_{d} s} .$$

Stability Analysis of Non-Collocated vs. Collocated Architectures

It is important to ensure system stability and smooth interaction performance for exoskeleton robots and users. Inspired by regulating the interaction dynamics via a desired impedance model, impedance control has been widely used for exoskeletons to provide a feasible solution to regulate the interaction performance. The impedance control was adopted and the stability of non-collocated SEA/QDD-based and collocated QDD-based exoskeletons was studied. In particular, the non-collocated SEA/QDD impedance transfer function and the QDD collocated impedance transfer function was first derived and the stability of the non-collocated SEA/QDD-based exoskeletons and collocated QDD based exoskeleton then compared.

### A. Impedance Transfer Function for Exoskeletons

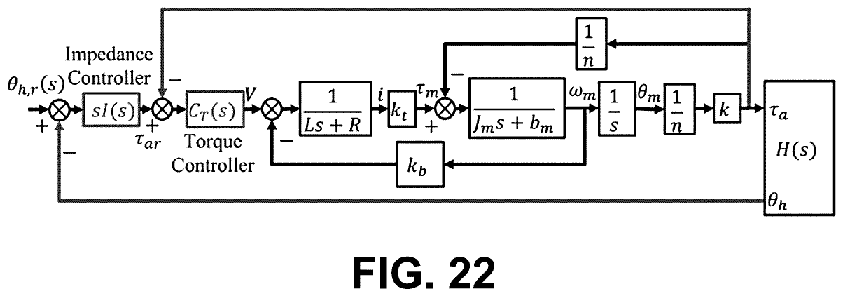

Non-collocated Impedance Control for SEA/QDD Actuator-based Exoskeleton: FIG. 22 is a block diagram representing a non-collocated impedance control scheme for exoskeletons with SEA and QDD actuator. In the non-collocated controller design, the signals from external sensors like torque sensors and encoders (located on the load side) serve as control feedback. The inner force controller C_{T}(s) is fed by an outer loop which measures the human joint angles and computes the force reference needed to obtain the desired impedance. For non-collocated impedance control, a proportional-derivative force control law is considered as:

sI(s)=k_{d}+b_{d}s. (52)

The inner force controller C_{T}(s) is designed as:

C_{T}(s)=kₚₜ+k_{dt}s. (53)

For the non-collocated control architecture, the impedance Z_{non-col}(s) at the human-robot interaction port (τₐ, \dot{θ}ₕ) can be computed as

$${Z}_{non - col} ( s ) = \frac{{τ}_{a} ( s )}{- s {θ}_{h} ( s )} = \frac{{\sum }_{n = 0}^{3} {N}_{n - cj} {s}^{j}}{{\sum }_{n = 0}^{4} {D}_{n - cj} {s}^{j}} , \qquad ( 54 )$$

with the following numerator coefficients:

N_{n-c3}=JₘLkn^{26i +J}ₘkk_{di}n²

N_{n-c2}=kk_{d}k_{di}k_{dt}+JₘRkn²+Lbₘkn²+Jₘkkₚᵢn²+bₘkk_{di}n²

N_{n-c1}=kk_{d}k_{di}kₚₜ+kk_{d}k_{dt}kₚi+Rbₘkn²+bₘkkₚᵢn²+kk_{b}kₜn²

N_{n-c0}=kk_{d}kₚᵢkₚₜ

and the denominator coefficients:

D_{c4}=JₘLn²+Jₘk_{d}in²

D_{c3}=kk_{d}ik_{d}t+JₘRn²+Lbₘn²+Jₘkₚin²+bₘk_{d}in²

D_{c2}=Lk+kk_{d}i+k_{b}kₜn²+kk_{d}ikₚt+kk_{d}tkₚi+Rbₘn²+bₘkₚin²

D_{c1}=(Rk+kkₚi+kkₚikₚt), D_{c0}=0

Note that the transfer functions of non-collocated impedance control for SEA/QDD exoskeletons have the same algebraic expressions, but the specific transfer functions are different due to different parameters. Z_{non-col}(s) in Eq. (52) does not incorporate the joint inertia Jₕ, damping bₕ and stiffness kₕ since these parameters belong to parts of the interacting environment (human-limbs).

Collocated Impedance Control for QDD Actuator-based Exoskeleton: For the collocated control architecture, as shown in FIG. 21A, the impedance Z_{col}(s) at the human-robot interaction port (τ, \dot{θ}ₕ) can be computed as:

$${Z}_{col} ( s ) = \frac{{τ}_{a} ( s )}{- s {θ}_{h} ( s )} = \frac{{\sum }_{n = 0}^{3} {N}_{ci} {s}^{i}}{{\sum }_{n = 0}^{4} {D}_{ci} {s}^{i}} , \qquad ( 55 )$$

with the following numerator coefficients:

$${N}_{c 3} = k ( {J}_{m} {Lkn}^{2} - {J}_{m} {Lk}_{d} {n}^{2} )$$

$${N}_{c 2} = k ( {J}_{m} {Rkn}^{2} - {J}_{m} {Rk}_{d} {n}^{2} + {Lb}_{m} {kn}^{2} - {Lb}_{m} {k}_{d} {n}^{2} )$$

$${N}_{c 1} = k ( {kk}_{d} {k}_{di} + {Rb}_{m} {kn}^{2} - {Rb}_{m} {k}_{d} {n}^{2} + {kk}_{b} {k}_{t} {n}^{2} - {k}_{b} {k}_{d} {k}_{t} {n}^{2} )$$

$${N}_{c 0} = {k}^{2} {k}_{d} {k}_{pi}$$

and the denominator coefficients:

D_{c4}=JₘLkn²−JₘLk_{d}n²

D_{c3}=JₘRkn^{26i -J}ₘRk_{d}n²+Lbₘkn²−Lbₘk_{d}n²

D_{c2}=Lk²+k²k_{d}i−Lkk_{d}+Rbₘkn²−Rbₘk_{d}n²+kk_{b}kₜn²−k_{b}k_{d}kₜn²

D_{c1}=(Rk²+k²kₚi−Rkk_{d}), D_{c0}=0

B. Stability Analysis: Non-Collocated SEA and QDD vs. Collocated QDD Exoskeletons

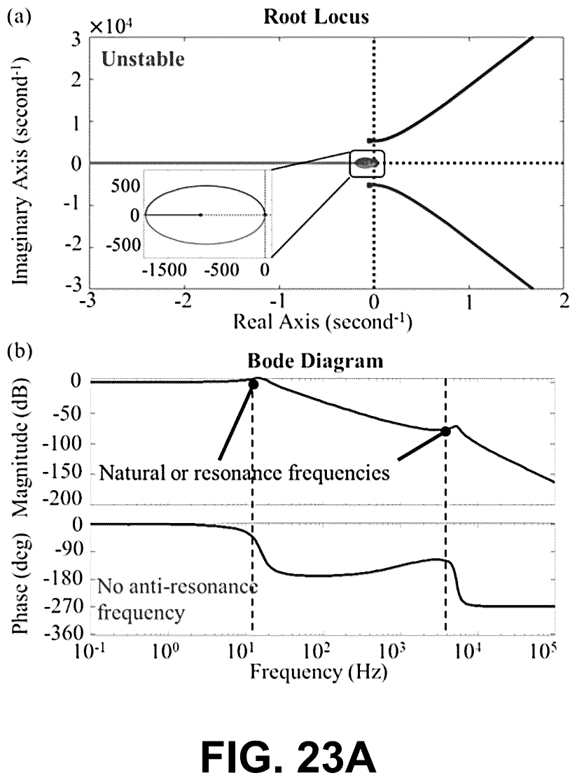

Based on the impedance control's transfer functions, the stability of state-of-the-art non-collocated SEA/QDD skeletons and the proposed collocated QDD exoskeleton was analyzed. The model parameters for the SEA and the QDD are summarized in Table I of FIG. 6. Notice that the non-collocated QDD and the collocated QDD exoskeleton have the same actuation mechanism. The results of the stability analysis comparison for non-collocated control of the SEA-based exoskeleton and collocated control of the QDD-based exoskeleton are shown in FIGS. 23A and 23B, respectively.

FIG. 23A shows the root locus and bode diagrams of the non-collocated control of SEA-based exoskeleton. The non-collocated architecture is less stable due to pole-zero flipping, which typically leads to unstable systems. In the bode diagrams of the non-collocated SEA-based exoskeleton system, there is no anti-resonant frequency in the resonant frequencies, and thus, there is no 180° phase lead. This has the effect of the second resonance having a phase of −270° leading to the system being unstable.

FIG. 23B shows the root locus and bode diagrams of the collocated control of QDD-based exoskeleton. In the root locus, all the roots do not cross the imaginary axis into the right s-plane since the alternating poles and zeros of the collocated architecture make the system stable. In bode diagrams, anti-resonance occurs between consecutive resonant frequencies, which results in 180° phase lead. Thus, the frequency response is always above −90°, making the system stable.

Based on the root locus plot, the system is stable if all roots are in the left-hand side of the s-plane. On the other hand, if any or all roots cross the imaginary axis to the righthand side of the s-plane, the system is unstable. The root locus diagrams of the SEA-based non-collocated control architecture compared to the QDD-based collocated control architecture are shown in FIGS. 23A and 23B, respectively. The root locus plots indicates that for the non-collocated control scheme, due to its right half-plane zeros, it extends to the right-hand of the s plane when the control gains are large. However, due to the interlacing poles and zeros, the roots of the collocated control scheme will always stay in the left-hand of the s plane. The collocated control system is more stable than non-collocated control because it can render a larger range of desired impedance. This is an important feature in wearable robot design since it increases its versatility allowing for more activities to be assisted by the wearable robot.

FIGS. 23A and 23B also illustrate the bode diagrams, including magnitude and phase, of the SEA-based non-collocated control architecture compared to the QDD-based collocated control architecture. Two natural (resonance) frequencies are in the two systems' magnitude diagrams. In the phase diagram of the non-collocated SEA system, the phase falls below −90°. This implies that the non-collocated SEA system will only be stable with a certain number of conditions and that the desired impedance should not be larger than the stiffness of the connection component. However, in the QDD-based collocated control exoskeleton, an anti-resonance frequency between two natural frequencies of a system results in a 180° phase lead. Therefore, the phase is always above −90°.

In terms of the non-collocated QDD-based exoskeleton, although its parameters are different from the non-collocated-based SEA system's, it has similar features (root locus extends to the right-hand of the s plane and without anti-resonance frequency in bode diagram) with the later. Therefore, the collocated QDD-based system can render a larger stability region than the non-collocated SEA/QDD system.

### High Fidelity Torque Estimation Without Torque Sensors

To eliminate the dependence on torque external sensing, a high-fidelity torque estimator was derived for the collocated controlled exoskeleton. The system identification methods employed to estimate the parameters \hat{k}, Ĵₘ, and \hat{b}ₘ of the proposed collocated controller and torque estimator are described. To demonstrate the superiority of the torque estimation method, it was compared with a current-based torque estimation method, which is a commonly used approach in the field.

### A. Torque Estimator Design and System Identification

Torque Estimator. From the derived expression of assistive torque τₐ, by the certainty equivalence principle, the torque estimator can be rewritten as:

$${\hat{τ}}_{a} = \frac{\hat{k}}{k - {k}_{d}} ( {k}_{d} + {b}_{d} s ) ( {θ}_{h , r} - \frac{1}{n} {θ}_{m} ) . \qquad ( 56 )$$

Identification of \hat{k}: Accurate system parameters contribute to high-fidelity torque estimation. Exoskeletons are always in contact with human limbs, so consider the effects of human muscles and wearable connections when identifying the transmission stiffness \hat{k}, which is typically ignored. Therefore, \hat{k} is the comprehensive stiffness of rigid transmission, human muscles, and wearable connects, which value is usually one or two orders of magnitude smaller than the single rigid transmission.

To identify this parameter, an individual wears the exoskeleton with the leg fixed (meaning θₕ(t)=0). Then the input current i(t) is set as 0.01 Hz sine function and the output data (motor angle θ, angular velocity \dot{θ}ₘ and acceleration \ddot{θ}ₘ) can be measured as τₐ. based on Eqs. (43) and (44),

$$\hat{k} [ \frac{1}{n} {θ}_{m} - {θ}_{h} ] = n [ {τ}_{m} - {\hat{J}}_{m} {\ddot{θ}}_{m} - {\hat{b}}_{m} {\dot{θ}}_{m} ] , \qquad ( 57 )$$

where τₘ=kₜ*i and θₕ(t)=0. The value \hat{k} can be given by rewriting the above equation:

$$\hat{k} = \frac{n [ {k}_{t} i - {\hat{J}}_{m} {\ddot{θ}}_{m} - {\hat{b}}_{m} {\dot{θ}}_{m} ]}{\frac{1}{n} {θ}_{m}} . \qquad ( 58 )$$

Identification of Ĵₘ, and \hat{b}ₘ: First, the QDD actuator should be set as free motion (which means τ₁=0), and the input current reference i is given as a step function K*1(t) (K is a constant). Then collect the output data angular velocity \dot{θ}ₘ(=). Based on Newton's second theorem, then:

Ĵₘ\ddot{θ}ₘ+\hat{b}ₘ\dot{θ}ₘ+τ₁=Kkₜi. (59)

After Laplace transfer, Eq. (59) becomes:

Ĵₘωₘ(s)s+\hat{b}ₘωₘ=KkₜI(s). (60)

Using the final value theorem in Eq. (60), by letting s→0, the value of \hat{b}ₘ can be obtained:

$${\hat{b}}_{m} = \frac{K}{{ω}_{m , ss}} . \qquad ( 61 )$$

where ω_{m,ss} stands for the steady state of ωₘ.

The system is two order system, so the output ωₘ abides by:

$${ω}_{m} = \frac{K}{{\hat{b}}_{m}} ( 1 - {e}^{- \frac{{\hat{b}}_{m}}{{\hat{J}}_{m}} t} ) . \qquad ( 62 )$$

The value of time constant T can be obtained from output data ωₘ using the initial value and 1−e⁻¹ of the final value. The Ĵₘ can be obtained based on the relationship T=Ĵₘ/\hat{b}ₘ. Finally, the parameter k can be identified using Ĵₘ, and \hat{b}ₘ.

### B. Comparison Between Current-Based Method and Torque Estimator Method

Torque estimation can enable real-time sense and feedback of output torque in exoskeletons, particularly when torque sensors are unavailable. A commonly used approach is using current to estimate torque, i.e., τ=nkₜi, where n is the transmission gear ratio, kₜ is the torque constant, and i is the motor's current. To understand the performance of the proposed torque estimator, the current-based method and the proposed method was compared for different gear ratios and frequencies.

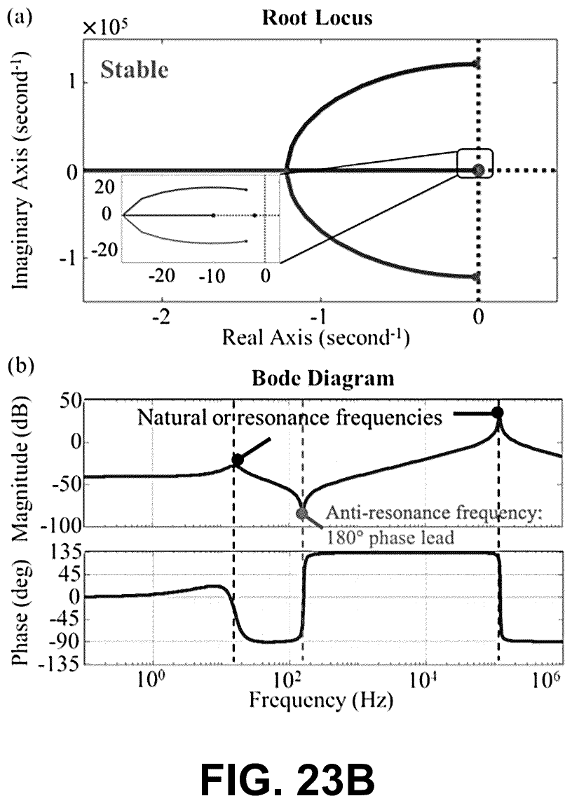

High gear ratio comes with various dynamic effects that are very difficult to model and reduce the accuracy of torque estimation—including vibration, backlash, and friction. FIG. 24 illustrates a comparison between current-based and the torque estimation method for different gear ratios and frequencies. Plot (a) of FIG. 24 shows simulation results of the estimation errors of the two estimation methods with different gear ratios under the same input (sine wave with 1 Hz frequency) and system parameters. The upper solid line represents the estimation error (% of the desired peak torque) results of the current-based estimation method, the lower solid line represents the estimation error of the torque estimation method, and the dotted line represents the difference between the two errors. With the increase of gear ratio, it was found that the estimation errors of the two methods will increase, and the error of the proposed approach is smaller than that of the current-based method. If the estimation error is less than 20%, the current-based process needs the gear ratio to be less than 8, while the proposed method needs the gear ratio to be less than 15. The extended range of the reduction ratio selection implies that, for a given motor, the exoskeleton employing the torque estimation method can opt for a larger reduction ratio, thereby amplifying the motor torque and consequently resulting in an increased output torque and more powerful exoskeleton.

The ideal torque estimator of the exoskeleton can estimate the output torque with high fidelity at different frequencies. Plots (b) and (c) of FIG. 24 illustrate the estimation errors of the two estimation methods under the same gear ratio (=6) at different frequencies (0.5-2 Hz) with input. Plots (b) show that with the increase of frequency, the estimation result based on current becomes worse, and even at 2Hz, the estimation error is even greater than 20%, which is acceptable in the exoskeleton field. Plots (c) show that the error of the torque estimation method is always less than 4% for different frequencies. This is because the proposed method uses real-time information on human and robot movements, which can greatly improve estimation accuracy.

### Experiments

To characterize the proposed collocated controller and estimation method, both benchtop experiments and human trials were conducted. An experimental setup with the knee exoskeleton is first presented and then the performance of the collocated impedance controller in a QDD actuator-based knee exoskeleton is shown. Next, experimental results with collocated and non-collocated controllers are shown and their stability compared. The torque estimation results are also compared between the proposed method and the existing current-based methods in benchtop and human experimental setups. The results demonstrate the accuracy of the model of the human exoskeleton system.

### A. Experiment Setup

The experiments were conducted in a benchtop mode with the customized QDD actuator secured to the desk with two vice-clamps and with four healthy human subjects wearing our knee exoskeleton, as shown in FIG. 10. The QDD actuator comprises a custom high torque density brushless direct current motor with 3.3 Nm peak torque, an embedded 6:1 planetary gear, a 14-bit magnetic encoder (AS5048A, AMS, USA), and a microcontroller (STM32F407, STMicroelectronics, France). The bilateral knee exoskeleton comprises a QDD actuator and a custom torque sensor connected to the thigh and shank support frames, respectively.

During the benchtop test and human test, a customized commercial torque sensor was used to measure actual output torque for comparing the accuracy of torque estimation results. In the human subject experiments, the healthy subjects wore the knee exoskeleton on both legs, with the actuators mounted parallel to the subject's knee joint. The knee actuator was placed with 3D printed braces, velcro straps, elastic bands, and a waistband, as shown in diagram A of FIG. 10. Four healthy subjects (2 male and 2 female) were instructed to walk at 0.5, 1.0, and 1.5 m/s and run at 2.0 m/s on a level treadmill for 2 minutes. All subjects were informed of the experiment protocol and consented before participating in the experiments.

### B. Collocated Control Torque Tracking Performance in QDD Actuator-Based Exoskeleton

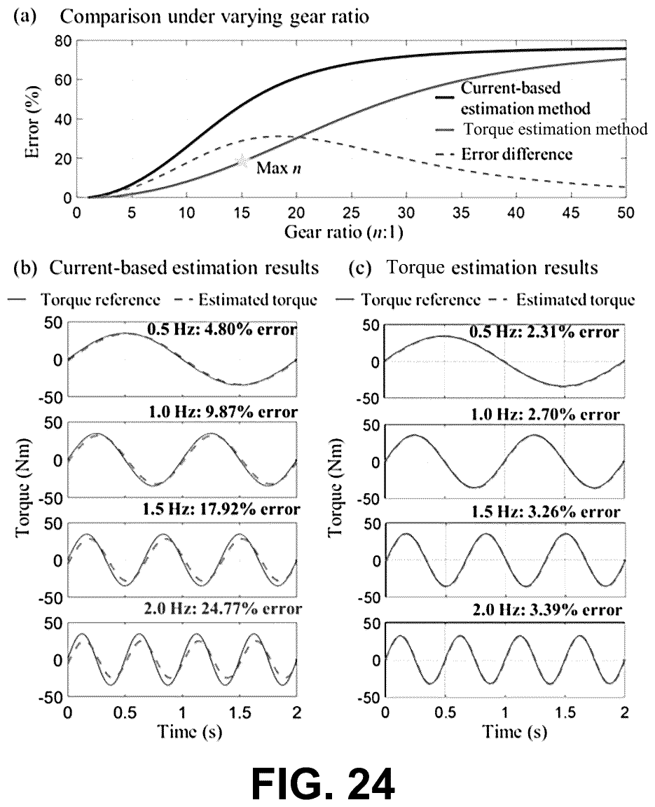

The exoskeleton always works with its wearer at different movement speeds. To illustrate the benefit of our proposed collocated controller, a torque tracking experiment was conducted under continuous varying speeds from walking to running (the treadmill velocity changed from 0.5 to 2.0 m/s), as shown in FIG. 25. Compared to the torque references and measured torque, FIG. 25 shows the accurate torque tracking of the exoskeleton under varying speeds, with only 4.70% (RMS error 0.49±0.02 Nm). The results demonstrate that the controller with QDD actuator-based exoskeleton can provide accurate assistive torque to improve human mobility.

C. Stability Comparison: Non-Collocated vs. Collocated QDD Actuator-Based Exoskeleton

To compare the stability between the collocated and non-collocated control architectures with QDD actuators, a benchtop test was performed where the actuator was clamped between two vice clamps, as shown in image B of FIG. 10. In this test, the range of desired stiffness and damping parameters, k_{d}and b_{d}, that results in stable operation with collocated and non-collocated control schemes were explored. The stability of the motor was classified according to the following: for a particular selection of k_{d}, b_{d}, (i) if the motor ran smoothly for more than 30 seconds, it was concluded that the system was stable, (ii) if the motor ran for some time that was less than 30 seconds and eventually started making a loud noise and vibrated with a chattering sound, and finally shuts down, then the system was critically stable, (iii) if the motor produced a lot of noise and vibrated right from the beginning and shut down within 2 seconds, then the system was classified as unstable.

For comparing the stability between the collocated and non-collocated control schemes in the experiments, the lowest values of k_{d} and b_{d} in the range k_{d}∈[0, 1500] and b_{d}∈[0, 1] were first selected and the motor was then run for 30 seconds with a particular frequency of reference position trajectory. For the benchtop experiments, a reference trajectory as used as r(t)=10 sin(2πft), where f is the frequency of the desired reference trajectory in Hz. After 30 seconds, the value of k_{d} was changed in increments of 100 with fixed b_{d} until the maximum desired k_{d} was reached. Then, b_{d} was increased by 0.25 and the same process was repeated. Four groups of different experiments were conducted for non-collocated and collocated QDD actuator-based exoskeletons, respectively, where the frequency of the reference position trajectory was changed from 0.5 to 2 Hz in increments of 0.5 Hz and a stable range of k_{d} and b_{d} was explored.

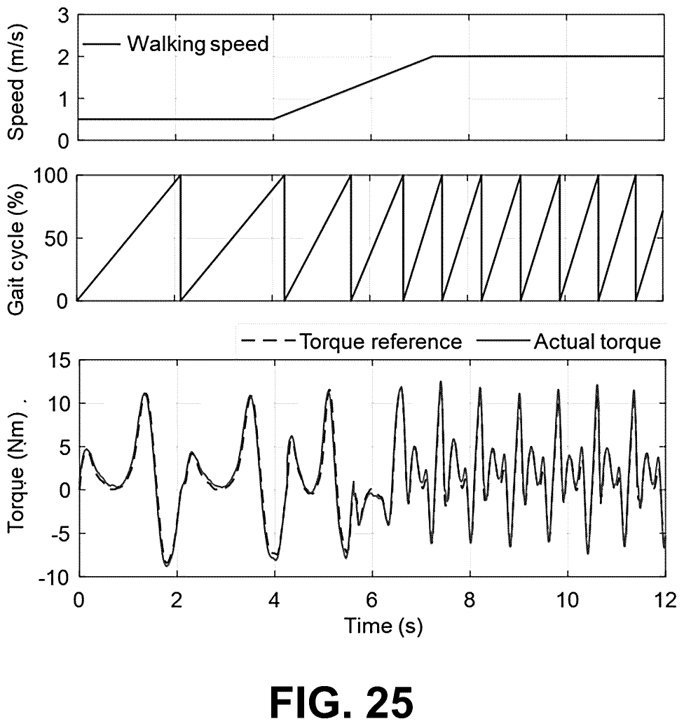

FIG. 15B shows an example of a stability test, which presents the experimental details of the collocated control experiment with k_{d}=1300, b_{d}=0 with a reference trajectory of 0.5 Hz when the actuator operation transitions from a stable to a critically stable region at time t=12s. It can be seen that the torque reference (top) changes rapidly, which in turn causes the actuator to produce a loud sound (about 80 dB) and severe oscillations in the motor current, angle and power. The sound was measured using a sound level meter (PCE Instruments, Jupiter, FL, USA) during the benchtop experiments. During the experiment, the system could not work stably for 30s, so it was considered as critical stability. This result is displayed in a lighter block indicated in FIG. 26.

FIG. 26 illustrates examples of stability test results for the non-collocated control (left) and the collocated control (right) in QDD-based exoskeleton. Stability results at different speeds demonstrate stable (darker shading), critically stable (lighter shading), and unstable (lightest shading) regions of the actuator operation for four different frequencies of the desired reference trajectory. FIG. 26 summarizes the stability comparison results of the non-collocated and collocated control for QDD actuator-based exoskeleton. The highest stiffness the non-collocated system can render is 600 Nm/rad, obtained in 0.5 and 1.0 Hz. At higher frequency inputs (1.5 and 2.0 Hz), the maximum stiffness that the system can render is only 500 Nm/rad. In contrast to the collocated control system, the largest value of stable k_{d} for slow speeds (0.5 and 1 Hz) was obtained for b_{d}=0, whereas for higher speeds (1.5 and 2 Hz) the largest value of stable k_{d} was obtained for non-zero values of bd. In particular, the largest value of stable k_{d} was 1200 and 1000 Nm/rad for 0.5 and 1 Hz, respectively, and 1000 and 900 Nm/rad for 1.5 Hz and 2 Hz, respectively. According to the experimental results, it was found that, compared with non-collocated control (utilizing torque sensors), adopting the collated control (without torque sensors) can significantly improve the stiffness and damping range that the same QDD actuator-based exoskeleton can render, i.e., improve stability.

D. Torque Estimation Comparison between Current-based Method and Torque Estimator Method

Benchtop Tests: To validate the accuracy of the torque estimation method in an ideal situation, the actuator was held in place with vice clamps to simulate a perfectly fitted condition of the worn exoskeleton while a sine wave signal was passed to it. To simulate the human knee angle, θ_{h,r}, over a gait cycle at different speeds as an input, four sine wave command signals were sent at 4 different frequencies (0.5 Hz, 1.0 Hz, 1.5 Hz, and 2.0 Hz). The objective was to estimate torque using our proposed method and quantify its similarity with the actual torque measured by the torque sensor. The estimated accuracy at each frequency was evaluated using the root mean square error (RMSE) between the torque estimated and the actual torque measured. Furthermore, to establish the superior performance of our method over the alternative method, the same process was repeated using the current-based torque estimation method.

The result of the experiment is shown in FIG. 13 where column (A) illustrates estimation accuracy using current based torque estimation method and column (B) illustrates estimation accuracy using the torque estimation method. The RMSE for all four speeds is below 0.6, with the lowest RMSE being 0.35 Nm at 1.5 Hz and an average RMSE of 0.43 Nm. To provide better assistance to the wearer, the assistive torque should be able to provide a proper ratio of biological torque. When factoring the peak torque for each speed, the 1.0 Hz speed has the lowest RMSE per average peak percentage at 3.90% with an average peak torque of 9.50 Nm. The current-based estimation method was assessed using both filtered and unfiltered signals. However, the average peak torque was 11.5 Nm, irrespective of being filtered or unfiltered. With the average peak torque staying constant throughout the different speeds, the RMSE per average peak percentage was directly proportional to the RMSE. The RMSE increased with speed regardless of whether the current signals were filtered or not. Generally, the error would increase with the speed as observed for a current-based estimator. Although the proposed estimation method showed a similar upward trend as the speed increased, it had a lower RMSE. Thus, the result affirms that the proposed torque estimation method can perform better than the current-based torque estimation method using current.

Human Walking and Running Experiments: Experiments were also conducted with four healthy subjects to validate the performance of the proposed method in a dynamic environment under real-world human-robot interaction. The subjects were asked to walk on a flat treadmill at four different speeds (0.5 m/s, 1.0 m/s, 1.5 m/s, and 2.0 m/s). The objective was to quantify the accuracy with which the actuator estimated assistive torque compared to the actual assistive torque measured by the torque sensor.

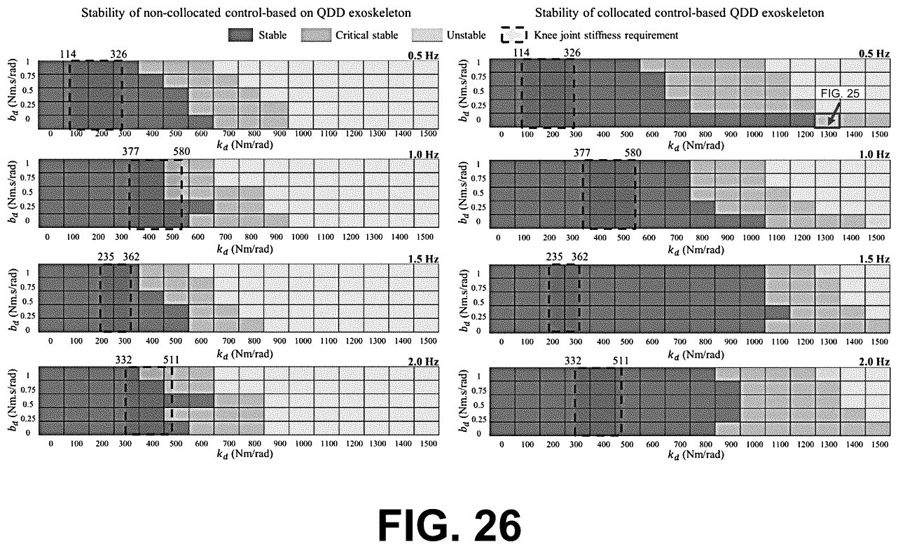

The powered walking results using the current-based torque estimation control (left) compared to the proposed torque estimation method control (right) are illustrated in the plots of FIG. 27. The motor current-based torque estimation method had an RSM error of 1.43 Nm for 1.0 m/s walking and 2.50 Nm for 2.0 m/s running, corresponding to 12.4% and 20.8% of the peak amplitude. Our torque estimation method showed significantly more accurate torque estimation with an RMS error of 0.46 Nm for walking and 0.47 Nm for running, corresponding to 4.6% and 5.0% of the peak amplitude. The results show that the average RMSE for all four speeds using the proposed method is 0.42Nm, while the current-based method had a higher average RSME of 1.5Nm. Therefore, using the proposed torque estimation method lowered the RSME by 71.8667%. Like the benchtop experiments, the error increased as the subject increased their speeds using the current-based torque estimation method. The error also increased when the subject increased the speeds using our method, but the error remained closer to the average throughout all four speeds. In addition to the error, it was also found that the current estimation method will have phase delay, and with the increase of frequency, the delay will become more and more apparent (from 1.96% in walking to 4.02% in running). Phase delay increases the energy penalty from the exoskeleton, and a 2.5% timing has been shown to be a delay that cannot be ignored in wearable systems. However, the proposed estimation method has almost no estimation error (≤0.01%). This illustrates that the proposed method has a higher torque tracking accuracy than the commonly used state-of-the-art current-based torque estimation method.

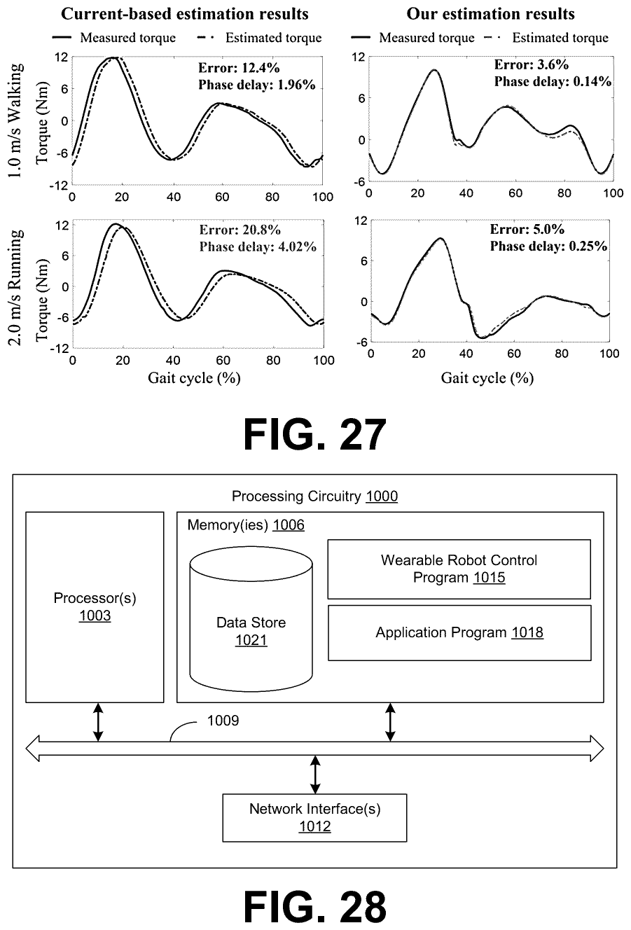

Referring next to FIG. 28, shown is a schematic diagram illustrating an example of processing circuitry 1000 that can be used for control of wearable robots such as, e.g., exoskeletons or other applications, in accordance with various embodiments of the present disclosure. The processing circuitry 1000 can comprise one or more computing/processing device such as, e.g., a smartphone, tablet, computer, controller, etc. The processing circuitry 1000 can include processing circuitry comprising at least one processor circuit, for example, having a processor 1003 and a memory 1006, both of which are coupled to a local interface 1009. To this end, each processing circuitry 1000 may comprise, for example, at least one server computer or like device, which can be utilized in a cloud based environment. The local interface 1009 may comprise, for example, a data bus with an accompanying address/control bus or other bus structure as can be appreciated.

In some embodiments, the processing circuitry 1000 can include one or more network interfaces 1012. The network interface 1012 may comprise, for example, a wireless transmitter, a wireless transceiver, and/or a wireless receiver. The network interface 1012 can communicate to a remote computing/processing device or other components using a Bluetooth, WiFi, or other appropriate wireless protocol. As one skilled in the art can appreciate, other wireless protocols may be used in the various embodiments of the present disclosure. The network interface 1012 can also be configured for communications through wired connections.

Stored in the memory 1006 are both data and several components that are executable by the processor(s) 1003. In particular, stored in the memory 1006 and executable by the processor 1003 can be a wearable robot control application 1015 which can utilize the most significant cell methodology as disclosed herein, and potentially other applications 1018. In this respect, the term “executable” means a program file that is in a form that can ultimately be run by the processor(s) 1003. Also stored in the memory 1006 may be a data store 1021 and other data. In addition, an operating system may be stored in the memory 1006 and executable by the processor(s) 1003. It is understood that there may be other applications that are stored in the memory 1006 and are executable by the processor(s) 1003 as can be appreciated.

Examples of executable programs may be, for example, a compiled program that can be translated into machine code in a format that can be loaded into a random access portion of the memory 1006 and run by the processor(s) 1003, source code that may be expressed in proper format such as object code that is capable of being loaded into a random access portion of the memory 1006 and executed by the processor(s) 1003, or source code that may be interpreted by another executable program to generate instructions in a random access portion of the memory 1006 to be executed by the processor(s) 1003, etc. Where any component discussed herein is implemented in the form of software, any one of a number of programming languages may be employed such as, for example, C, C++, C#, Objective C, Java®, JavaScript®, Perl, PHP, Visual Basic®, Python®, Ruby, Flash®, or other programming languages.

The memory 1006 is defined herein as including both volatile and nonvolatile memory and data storage components. Volatile components are those that do not retain data values upon loss of power. Nonvolatile components are those that retain data upon a loss of power. Thus, the memory 1006 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1003 may represent multiple processors 1003 and/or multiple processor cores, and the memory 1006 may represent multiple memories 1006 that operate in parallel processing circuits, respectively. In such a case, the local interface 1009 may be an appropriate network that facilitates communication between any two of the multiple processors 1003, between any processor 1003 and any of the memories 1006, or between any two of the memories 1006, etc. The local interface 1009 may comprise additional systems designed to coordinate this communication, including, for example, ultrasound or other devices. The processor 1003 may be of electrical or of some other available construction.

Although the wearable robot control application 1015, and other various applications 1018 described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Also, any logic or application described herein, including the wearable robot control application 1015, that comprises software or code can be embodied in any non-transitory computer-readable medium for use by or in connection with an instruction execution system such as, for example, a processor 1003 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system.

The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Further, any logic or application described herein, including the wearable robot control application 1015, may be implemented and structured in a variety of ways. For example, one or more applications described may be implemented as modules or components of a single application. For example, the wearable robot control application 1015 can include a wide range of modules such as, e.g., an initial model or other modules that can provide specific functionality for the disclosed methodology. Further, one or more applications described herein may be executed in shared or separate computing/processing devices or a combination thereof. For example, a plurality of the applications described herein may execute in the same processing circuitry 1000, or in multiple computing/processing devices in the same computing environment. To this end, each processing circuitry 1000 may comprise, for example, at least one server computer or like device, which can be utilized in a cloud based environment.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt% to about 5 wt%, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include traditional rounding according to significant figures of numerical values. In addition, the phrase “about ‘x’ to ‘y’” includes “about ‘x’ to about ‘y’”.

Therefore, at least the following is claimed:

1. A method for control of a wearable robot without torque sensors, comprising:
generating a control signal for a quasi-direct-drive (QDD) actuator of the wearable robot, the control signal determined by a collocated impedance controller based upon current and angle of rotation of the QDD actuator and a reference trajectory angle; and
adjusting operation of the QDD actuator based upon the control signal.

2. The method of claim 1, wherein current supplied to the QDD actuator is adjusted in response to the control signal.

3. The method of claim 2, wherein the collocated impedance controller comprises:
an impedance controller configured to generate a reference torque based upon a comparison of the angle of rotation and the reference trajectory angle; and
a current controller configured to control current supplied to the QDD based upon a comparison of the current of the QDD actuator and a reference current associated with the reference torque.

4. The method of claim 1, wherein the reference trajectory angle is provided by a high-level controller of the wearable robot.

5. The method of claim 4, wherein the reference trajectory angle is based upon limb phase of a user of the wearable robot.

6. The method of claim 1, wherein the QDD actuator comprises a high torque density motor coupled to a low inertia transmission coupled to a joint of the wearable robot.

7. The method of claim 6, wherein the wearable robot is an exoskeleton.

8. The method of claim 7, wherein the exoskeleton is a knee exoskeleton, a hip exoskeleton or an elbow exoskeleton.

9. A wearable robot, comprising:
a support structure configured to interface with a user;
a quasi-direct-drive (QDD) actuator coupled to the support structure; and
processing circuitry configured to:
generate a control signal for the QDD actuator, the control signal determined by a collocated controller based upon current and angle of rotation of the QDD actuator and a reference trajectory angle, where the collocated controller is a collocated impedance controller, a collocated direct torque controller or a collocated admittance controller; and
adjust operation of the QDD actuator based upon the control signal.

10. The wearable robot of claim 9, wherein current supplied to the QDD actuator is adjusted in response to the control signal.

11. The wearable robot of claim 10, wherein the collocated impedance controller comprises:
an impedance controller configured to generate a reference torque based upon a comparison of the angle of rotation and the reference trajectory angle; and
a current controller configured to control current supplied to the QDD based upon a comparison of the current of the QDD actuator and a reference current associated with the reference torque.

12. The wearable robot of claim 9, wherein the reference trajectory angle is provided by a high-level controller of the wearable robot.

13. The wearable robot of claim 12, wherein the reference trajectory angle is based upon limb phase of a user of the wearable robot.

14. The wearable robot of claim 9, wherein the QDD actuator comprises a high torque density motor coupled to a low inertia transmission coupled to a joint of the wearable robot.

15. The wearable robot of claim 14, wherein the wearable robot is an exoskeleton.

16. The wearable robot of claim 15, wherein the exoskeleton is a knee exoskeleton, a hip exoskeleton or an elbow exoskeleton.
